(19) United States
(12) Patent Application Publication
(10) Pub. No.: US 2024/0291215 A1
(43) Pub. Date: Aug. 29, 2024

(54) ELECTRICAL CONNECTOR

(71) Applicant: Apple Inc., Cupertino, CA (US)

(72) Inventors: Stephen E. Yao, San Mateo, CA (US); Varun K. Sanghvi, Sunnyvale, CA (US); Christopher K. Graham, San Francisco, CA (US)

(21) Appl. No.: 18/597,790

(22) Filed: Mar. 6, 2024

Related U.S. Application Data
(63) Continuation of application No. PCT/US2022/076413, filed on Sep. 14, 2022.
(60) Provisional application No. 63/261,257, filed on Sep. 15, 2021.

(51) Int. Cl. H01R 24/00; G02B 27/01; H01R 13/506; H01R 13/62; H01R 13/625; H01R 13/635; H01R 24/86

(52) U.S. Cl. CPC H01R 24/005; G02B 27/0176; H01R 13/506; H01R 13/6205; H01R 13/625; H01R 13/635; H01R 24/86

(57) ABSTRACT

An electronic device can include an enclosure and a receptacle disposed on the enclosure. The receptacle can form a recess which interlocks or otherwise engages with a plug connector of a cable assembly. The plug connector can include a boot, a central protrusion coupled to the boot, and one or more flanges extending laterally from the central protrusion. The receptacle can include one more detents disposed within the recess. Each of the one or more detents can interlock with a respective flange of the central protrusion. The detents can be biased to extend into the recess by one or more biasing elements. Each of the detents can form an angled surface which interfaces with a respective flange to retain the plug connector within the receptacle.

### CROSS-REFERENCE TO RELATED APPLICATION(S)

This application is a continuation of International Application No. PCT/US2022/076413, filed 14 Sep. 2022, and entitled “ELCTRICAL CONNECTOR,” which claims priority to U.S. Provisional Patent Application No. 63/261,257, filed 15 Sep. 2021, and entitled “ELECTRICAL CONNECTOR,” the disclosures of which are hereby incorporated by reference in their entireties.

### FIELD

The described embodiments relate generally to cables and wires of electronic devices. More particularly, the present embodiments relate to coupling a connector to an electronic device.

### BACKGROUND

Electronic devices are increasingly being designed with device portability in mind, for example, to allow users to use these devices in a wide variety of situations and environments. Indeed, power sources, such as lithium batteries, can power an electronic device for a substantial duration of time and in a variety of indoor and outdoor environments. Components within an electronic device, such as, a processor, memory, antennas, and other components, can be disposed within a portable housing to protect the components from damage or failure induced by an environment external to the housing. Improvements and advances to portable electronic devices can be desirable to provide additional functionality in a variety of situations and environments.

### SUMMARY

According to some aspects of the present disclosure, a receptacle connector of an electronic device can include a trim ring and a base. The trim ring and the base can define or form a recess. The receptacle connector can include a detent disposed in the recess. The detent can define a channel configured to rotatably receive at least a portion of a corresponding plug connector. The receptacle connector can include an electrical contact disposed within the recess.

In some examples, the receptacle connector can include a raised portion disposed within the recess and extending from the base. The electrical contact can be coupled to the raised portion. The receptacle connector can include a spring that biases the detent toward the raised portion. The spring can be one of a canted coil spring or a leaf spring. The detent can form a first surface that is angled relative to a second surface. A flange of the plug connector can extend into the channel and contact the first surface.

In some examples, the plug connector is receivable within the recess in a first orientation and a flange of the plug connector inhibits the plug connector from being extracted from the recess when the plug connector is in a second orientation relative to the plug connector. The receptacle can also be configured to permit rotation of the plug connector from the first orientation to the second orientation. In some examples, extracting the plug connector from the recess while the plug connector is in the first orientation requires less force than extracting the plug connector from the recess while the plug connector is in the second orientation. The force required to extract the plug connector from the recess while the plug connector is in the second orientation can be at least 3 Nm.

In some examples, the electrical contact can include a first electrical contact and the receptacle connector can include a second electrical contact. The first electrical contact can define a first contact area that is different than a second contact area defined by the second electrical contact. In some examples, the receptacle connector can include a second detent and a third detent disposed in the recess. Additionally, the receptacle connector can include a first canted coil spring biasing the first detent towards the raised portion, a second canted coil spring biasing the second detent toward the raised portion, and a third canted coil spring biasing the third detent toward the raised portion. The receptacle connector can also include a seal disposed adjacent to the raised portion.

According to some examples, a plug connector can include a boot and a central protrusion. The central protrusion can include an internal surface and an external surface. The internal surface can define or form a cavity. The plug connector can include a first metal flange having a first width extending from the external surface, a second metal flange having a second width different than the first width extending from the external surface. The central protrusion can be configured to be inserted into a corresponding receptacle connector when the central protrusion is in a first orientation, and the first and second flanges are configured to prevent the central protrusion from being inserted into the corresponding receptacle connector when the central protrusion is in a second orientation.

In some examples, the plug connector can further include an electrical contact disposed adjacent the internal surface and extending into the cavity. The electrical contact can be one of a plurality of electrical contacts disposed about the internal surface and extending into the cavity. The external surface of the central protrusion can be substantially parallel to the internal surface of the central protrusion. The central protrusion can have a circular cross-sectional profile or shape. The plug connector can include one or more magnets disposed within the boot. The plug connector can include a seal contacting the central protrusion. The plug connector can further include a third metal flange extending from the external surface, and the first flange, the second flange, and the third flange can all be offset relative to one another.

According to some aspects, a cable assembly can include a cable and a plug connector electrically coupled to the cable. The plug connector can include a boot, a central protrusion, electrical contacts, and flanges. The central protrusion can be at least partially disposed within the boot. The central protrusion can form an internal surface and an external surface. The internal surface can define a cavity having a circular cross-sectional profile or shape. The electrical contacts can be disposed radially about the internal surface and extend into the cavity. The flanges can be radially disposed about the external surface and extend laterally from the external surface.

In some examples, the flanges can include a first flange, a second flange, and a third flange. The first flange can have a first width. The second flange can have a second width. The third flange can have a third width different from the first width and the second width. In some examples the cable is electrically coupled to a power source.

According to some examples, a head-mounted display can include a display portion, an electrical power source, and a support. The support can be coupled to the display portion and include an enclosure and a receptacle connector at least partially disposed within the enclosure. The head-mounted display can also include a cable assembly electrically coupling the electrical power source and the support.

In some examples, the support can include a band configured to wrap at least partially around a head coupled to the display portion at two or more locations. The support can be a first support and the head-mounted display can include a second support coupled to the display portion. The display portion can include a light-emitting diode (LED) display, an organic light-emitting diode (OLED) display, a liquid-crystal display (LCD) display, or a micro-LED display. In some examples, the head-mounted display can include a printed circuit board disposed within a cavity defined by the enclosure. The receptacle connector can be electrically coupled to the printed circuit board.

In some examples, the support can be electrically coupled to the display portion when the support is coupled to the display portion. In some examples, the receptacle connector can include a trim ring and a base disposed within the enclosure and connected to the trim ring. The trim ring and the base can define or form a recess. The receptacle connector can include a detent disposed in the recess. The detent can define a channel configured to receive at least a portion of a corresponding plug connector. The receptacle connector can include an electrical contact disposed within the recess.

According to an aspect of the present disclosure, a support for a head-mounted display can include an enclosure configured to be coupled to a display portion of the head-mounted display, an electrically conductive wire disposed within the enclosure, and a receptacle connector disposed on a distal end of the enclosure be electrically connected to the electrically conductive wire. The electrically conductive wire can be configured to at least partially define an electrical path between the receptacle connector and the display portion. The support can further include a display portion connector disposed on a proximal end of the enclosure and can be electrically connected to the electrically conductive wire.

In some examples, the display portion connector at the proximal end can include a plurality of contacts, and the receptacle connector disposed at the distal end can include a trim ring, a base connected to the trim ring. The trim ring and the base can define a recess. A detent can also be disposed on the recess. The detent can define a channel configured to rotatably receive at least a portion of a corresponding plug connector. In examples, the enclosure can be configured to be electrically coupled to the display portion at the proximal end. The receptacle connector can further include a canted coil spring biasing the detent. Additionally, or alternatively, the electronic component can include a printed circuit board (PCB) connected to the electrically conductive wire.

According to some examples of the present disclosure, a support for a head-mounted display can include an enclosure defining a proximal end and a distal end, and a receptacle connector disposed at least partially within the enclosure between the proximal end and the distal end of the enclosure. The receptacle connector can be configured to rotatably receive at least a portion of a corresponding plug connector. The receptacle connector can be configured to enable the plug connector to rotate relative to the receptacle connector. The receptacle connector can include a trim ring, a base connected to the trim ring, the trim ring and the base defining a recess. The receptacle connector can further include a biased detent disposed in the recess, the detent defining a channel configured to rotatably receive at least a portion of a corresponding plug connector.

In some examples, the receptacle connector can be configured to enable rotation of the plug connector relative to the receptacle connector in a first direction. The receptacle connector can be configured to substantially inhibit rotation of the plug connector relative to the receptacle connector in a second direction. For example, the receptacle connector can be configured to enable rotation of the plug connector relative to the receptacle connector in the first direction more than about 15 degrees. The receptacle connector can be configured to enable rotation of the plug connector relative to the receptacle connector in the second direction no more than about 15 degrees.

In some examples, the receptacle connector can further include a raised portion disposed within the recess and extending from the base, as well as a spring or a foam forcing the detent toward the raised portion. The biased detent can be disposed within the recess and define a channel configured to receive at least a portion of the plug connector. The raised portion can be disposed within the recess and extend from the base.

In some examples, the receptacle connector can include a detent configured to receive the portion of the plug connector when the receptacle connector is in a first orientation relative to the plug connector. The detent can be configured to inhibit extraction of the plug connector from the recess when the receptacle connector is in a second orientation relative to the plug connector. In some examples, the receptacle connector can be disposed at least partially within the enclosure at a location that is closer to the proximal end than the distal end. In some examples, the receptacle connector can be disposed at least partially within the enclosure at a location that is closer to the distal end than the proximal end. In some examples, the support can include a band portion coupled to the support, the band portion being configured to at least partially encircle a head.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective side view of an electronic device.

FIG. 1B shows a perspective side view of the electronic device.

FIG. 2A shows a partial side view of a cable assembly.

FIG. 2B shows a partial bottom view of the cable assembly.

FIG. 2C shows a partially exploded view of the cable assembly.

FIG. 3A shows a detail view of an electronic device.

FIG. 3B shows a top view of a receptacle connector.

FIG. 3C shows a partially exploded view of the receptacle connector.

FIG. 3D shows a perspective view of the receptacle connector.

FIG. 3E shows side view of the cable assembly and the electronic device.

FIG. 4A shows a bottom view of a cable assembly and an electronic device.

FIG. 4B shows a bottom view of the cable assembly and the electronic device.

FIG. 4C shows a bottom view of a cable assembly and an electronic device.

FIG. 4D shows a cross-sectional view of a cable assembly and receptacle connector.

FIG. 4E shows a bottom view of a portion of a receptacle connector.

FIG. 4F shows a cross-sectional view through the section line 4-4 in FIG. 4E.

FIG. 4G shows a perspective bottom view of the cable assembly and the electronic device.

FIG. 4H shows a partial cross-sectional view through the electronic device of FIG. 4A, according to one example.

FIG. 4I shows a partial cross-sectional view through the electronic device of FIG. 4A, according to another example.

FIG. 4J shows a partial cross-sectional view through the electronic device of FIG. 4A, according to another example.

FIG. 5A shows a perspective view of a cable assembly and an electronic device.

FIG. 5B shows a partially exploded view of the electronic device.

FIG. 5C shows an arrangement of magnets within the cable assembly and the electronic device.

FIG. 5D shows the arrangement of magnets within the cable assembly relative to the arrangement of magnets within the electronic device.

FIG. 6A shows a top perspective view of a cable assembly and an electronic device.

FIG. 6B shows a side view of the cable assembly and the electronic device.

FIG. 7A shows a top perspective view of a cable assembly and an electronic device.

FIG. 7B shows a side view of the cable assembly and the electronic device.

FIG. 8A shows a top perspective view of a cable assembly and an electronic device.

FIG. 8B shows a side view of the cable assembly and the electronic device.

FIG. 9A shows a top perspective view of a cable assembly and an electronic device.

FIG. 9B shows a top view of the electronic device.

FIG. 9C shows a partial cross-sectional side view of the electronic device and the cable assembly.

FIG. 9D shows a top perspective view of the cable assembly.

FIG. 10A shows a top perspective view of a cable assembly and an electronic device.

FIG. 10B shows a top view of the electronic device.

FIG. 10C shows a partial cross-sectional side view of the electronic device and the cable assembly.

FIG. 10D shows a cross-sectional view through the section line 10D-10D shown in FIG. 10C.

FIG. 11A shows a bottom perspective view of a plug connector.

FIG. 11B shows a bottom detail view of the plug connector and a receptacle connector.

FIG. 12A shows a side view of a plug connector.

FIG. 12B shows a top view of the plug connector.

FIG. 13A shows a side view of a plug connector.

FIG. 13B shows a top view of the plug connector.

FIG. 14A shows a side view of a plug connector.

FIG. 14B shows a top view of the plug connector.

FIG. 15A shows a side view of a plug connector.

FIG. 15B shows a top view of the plug connector.

### DETAILED DESCRIPTION

Reference will now be made in detail to representative embodiments illustrated in the accompanying drawings. The following descriptions are not intended to limit the embodiments to one preferred embodiment. To the contrary, it is intended to cover alternatives, modifications, and equivalents as can be included within the spirit and scope of the described embodiments as defined by the appended claims.

Portable electronic devices, such as smart phones, laptops, tablet computing devices, smart watches, head-mounted displays (HMD), and headphones, have become commonplace for persons undertaking daily activities (travel, communication, education, entertainment, employment, etc.). Indeed, portable electronic devices can provide assistance in completing daily tasks and errands, such as, watching an instructional video or monitoring progress during and after an exercise routine. However, some electronic devices necessarily require a temporary or permanent cabled connection to operate (e.g., charging the device, providing electrical power to an electronic component, interconnecting a peripheral input or output device, etc.).

In some circumstances, abruptly or accidentally removing electrical power and/or control signals from an electronic device can damage the components of the electronic device or data stored on the electronic device. As such, cabled connections that do not unwantedly or accidentally disconnect can be desirable. For example, a cable assembly that reliably interlocks with the electronic device to limit unwanted or accidental extraction of the cable assembly. Additionally, or alternatively, the cable assembly and a receptacle connector of the electronic device can be configured to enable unwanted or accidental extraction of the cable assembly without damage to the electronic device or loss of data.

One aspect of the present disclosure relates to an electronic device including an enclosure and a receptacle connector disposed on the enclosure. The electronic device can be a smart phone, laptop, tablet computing device, smart watch, head-mounted display (HMD), headphones, or any other electronic device. The receptacle connector can form a recess which interlocks or otherwise engages with a plug connector of a cable assembly. In some examples, the plug connector can include a boot, a central protrusion coupled to the boot, and one or more flanges extending laterally from the central protrusion. The one or more flanges can extend laterally into a channel, or respective channels, formed within the recess of the receptacle connector.

In some examples, the receptacle connector can include one more detents disposed within the recess. Each of the one or more detents can interlock with a respective flange of the central protrusion. The detents can be biased to extend into the recess by one or more leaf springs, canted coil springs, elastic foam, a combination thereof, or another biasing element. Each of the detents can form an angled surface which interfaces with a respective flange to retain the plug connector within the receptacle connector. At least one of the spring force of the biasing element and the angle of the angled surface can correlate to a force required to extract the plug connector from the receptacle connector. In some examples, each respective angle of the angled surfaces can vary so the plug connector can be more easily extracted by lifting one side of the plug connector (e.g., a non-cable-side) than another side of the plug connector (e.g., a cable-side of the plug connector).

In some examples, the central protrusion can be rotated to interlock (or release) the plug connector and the receptacle connector. In other words, the plug connector can be rotatably received within the receptacle connector. Alternatively, a push-button, a latch, a slide-button, or another actuating mechanism can be used to interlock (or release) the plug connector and the receptacle connector. For example, an actuating mechanism can be incorporated into the boot of the plug connector. Additionally, or alternatively, one or more magnets can be disposed within the plug connector and/or the receptacle connector to orient the plug connector relative to the receptacle connector and/or retain the plug connector to the receptacle connector.

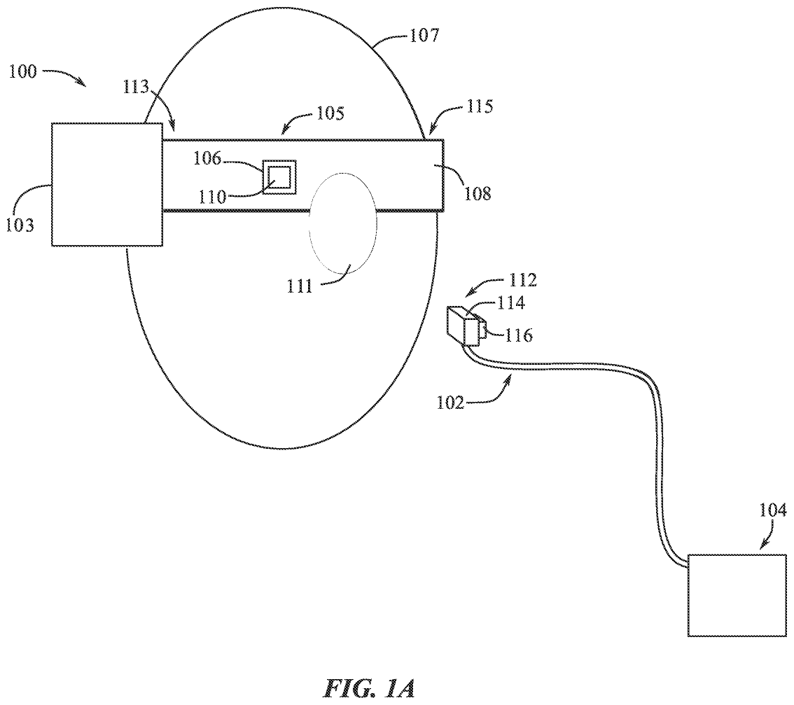

These and other embodiments are discussed below with reference to FIGS. 1A-15B. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A shows a first electronic device 100, a cable assembly 102, and a second electronic device 104. In some examples, the first electronic device 100 can be a head-mounted display (HMD) including a display portion 103 and one or more supports 105. While the first electronic device 100 is illustrated as a head-mounted display (HMD), the first electronic device 100 can be a tablet computing device, smart phone, smart watch, or any other electronic device in other examples. The display portion 103 can output visual content viewable by a user of the electronic device 100. For example, the display portion 103 can include a light-emitting diode (LED) display, an organic light-emitting diode (OLED) display, a liquid-crystal display (LCD) display, a micro-LED display, or the like. In some examples, the display portion 103 can be any form of display now known in the art, or as may be developed in the future.

The one or more supports 105 can retain the electronic device 100 relative to a head 107 of the user. In some examples, the first electronic device 100 can include a second support (not shown) that is coupled to the display portion 103 and configured to be positioned on the other side of the user's head 107. In some examples, the support 105 can be a band or can include a band portion coupled to the enclosure and can be configured to wrap around or otherwise encircle a portion of the user's head 107 and couple to the display portion 103 at two or more locations. In some examples, the band or band portion can be made of an elastomer material which can flex or stretch and thereafter return to an initial state.

The one or more supports 105 can each include a housing or an enclosure 108 formed from a polymer, metal, ceramic, or combination thereof. In some examples, the enclosure 108 can form a channel or cavity extending between a receptacle connector 106 to the display portion 103. The support 105 can be electrically coupled to the display portion 103 such that electrical signals and/or electrical power received at the receptacle connector 106 can be provided to the display portion 103 or other electronic components of the first electronic device 100. For example, one or more electronic components (e.g., printed circuit boards, processors, electrical wires, digital logic circuitry, digital processing circuitry, etc.) can be positioned within the cavity formed within the enclosure 108 and extend between the receptacle connector 106 and the display portion 103 to form an electrical path between the receptacle connector 106 and the display portion 103. In some examples, the one or more supports 105 can each be coupled to the display portion 103. For example, each support 105 can be welded, adhered, fastened, crimped, clipped, or otherwise retained by the display 103. In some examples, at least a portion of a proximal end (i.e., proximal end 113) of the support 105 can be electrically conductive or include electrical contacts to enable electrical power and/or electrical signals received by the receptacle connector 106 to be transferred to the display portion 103.

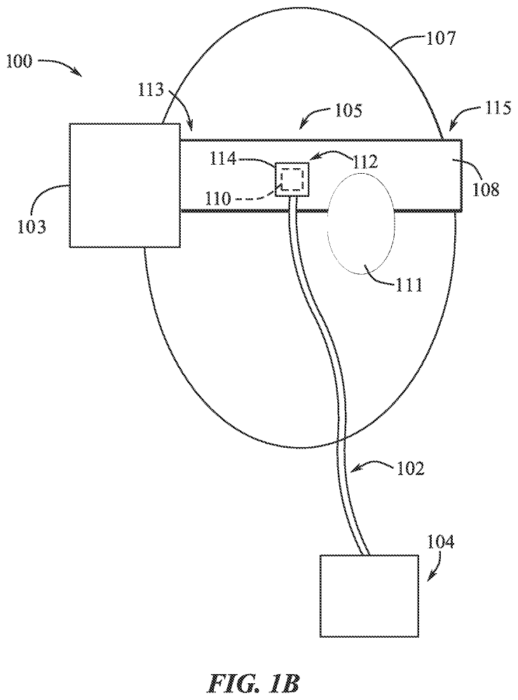

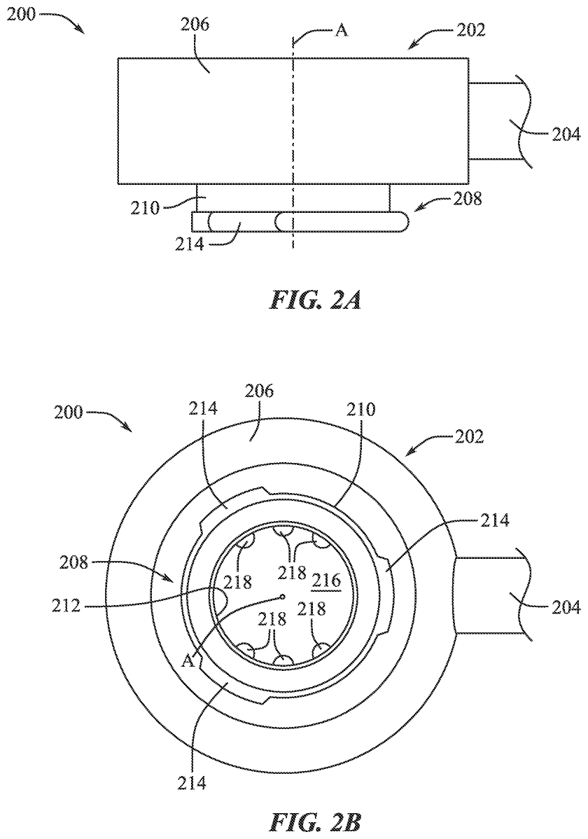

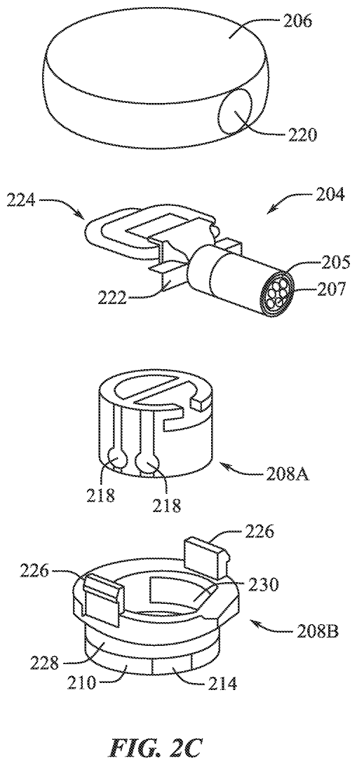

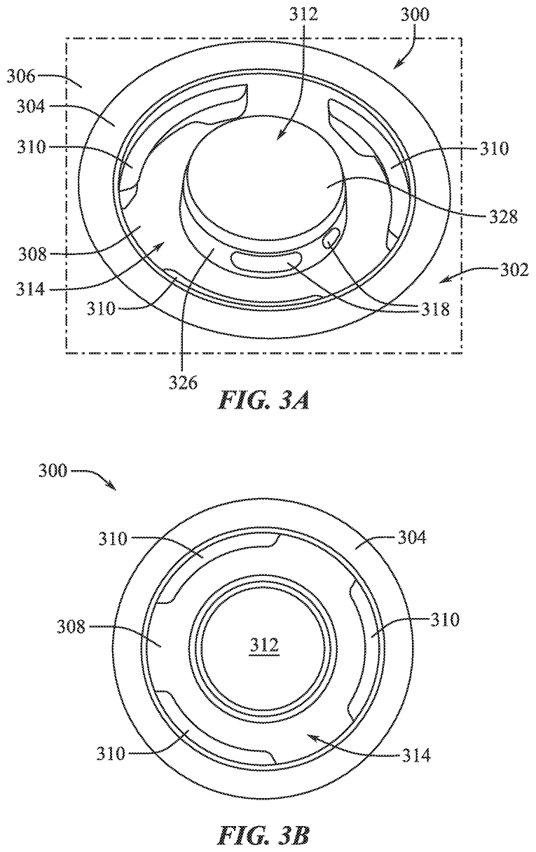

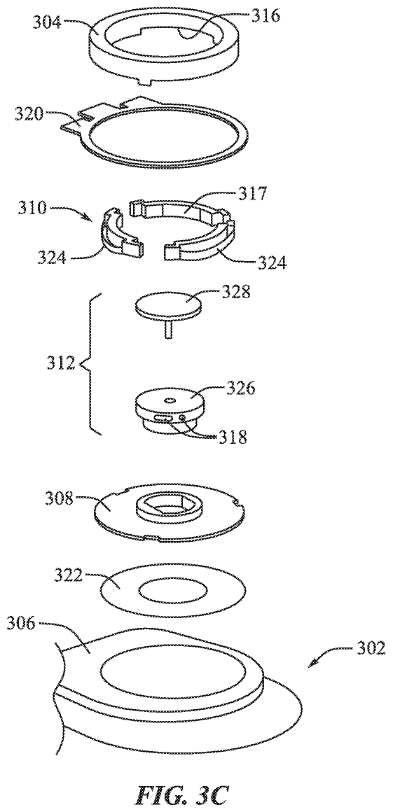

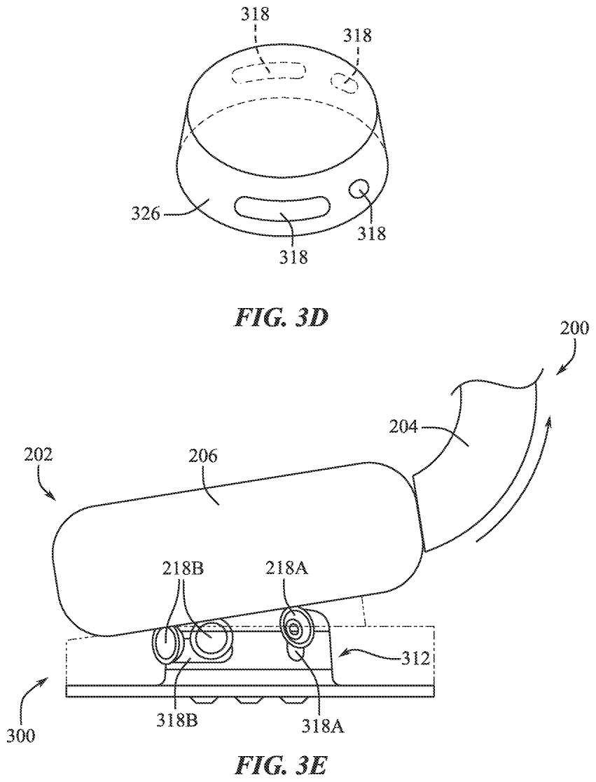

The first electronic device 100 can include the receptacle connector 106 disposed on or within the enclosure 108. The receptacle connector 106 can form a recess 110 that can receive a portion of the cable assembly 102. The cable assembly 102 can include a plug connector 112 at a distal end of the cable assembly 102. The plug connector 112 can include a boot 114 and a central protrusion 116 at least partially disposed within the boot 114. The central protrusion 116 can include one or more electrical contacts (not shown) that electrically couple the plug connector 112 to the first electronic device 100. In other words, as shown in FIG. 1B, the first electronic device 100 can be electrically coupled to the second electronic device 104 through the cable assembly 102 when the plug connector 112 is at least coupled to the receptacle connector 106 (e.g., the central protrusion 116 is at least partially disposed within the recess 110). Examples of the receptacle connector 106 and the plug connector 112 will be discussed in greater detail below with reference to FIGS. 2A-3E.

In some examples, the second electronic device 104 can provide electrical power and/or electrical signals to the first electronic device 100 through the cable assembly 102. For example, the second electronic device 104 can be an external electrical power source, such as, a lithium battery pack or other device capable of supplying electrical power to the first electronic device 100. While the present disclosure describes affixing the plug connector 112 of the cable assembly 102 to the receptacle connector 106 of the first electronic device 100, the principles and aspects described herein are equally applicable to a connection between the cable assembly 102 and the second electronic device 104. Additionally, or alternatively, the cable assembly 102 can electrically and physically couple to the second electronic device 104 using a different attachment mechanism. For example, the examples of attachment mechanisms and engagement features disclosed in Provisional Patent Application No. 63/261,254, filed 15 Sep. 2021, and entitled “ELECTRICAL CONNECTOR,” and Provisional Patent Application No. 63/261,254, filed 15 Sep. 2021, and entitled “ELECTRICAL CONNECTOR,” the disclosures of which are incorporated herein in their entireties, by the reference.

As illustrated in FIGS. 1A and 1B, the receptacle connector 106 can be positioned on or within the enclosure 108 of the support 105. In some examples, the receptacle connector 106 can be positioned on the enclosure 108 and disposed a distance from the display portion 103. That is, the plug connector 112 can operably couple to the enclosure 108 (i.e., the receptacle connector 106 on the enclosure 108) rather than directly coupling to the display portion 103. For example, the receptacle connector 106 can be disposed on or within the enclosure 108 such that the display portion 103 and the receptacle connector 106 are disposed on opposing sides of a user's ear 111. In some examples, the display portion 103 can be coupled to a proximal end 113 of the support 105 and the receptacle connector 106 can be positioned on or within a distal end 115 of the support 105. In some examples, the receptacle connector 106 can be disposed on or within the enclosure 108 between the proximal and distal ends 113, 115 of the support 105 such that the display portion 103 and the user's ear 111 are disposed on opposing sides of the receptacle connector 106 (as shown in FIGS. 1A and 1B). In some examples, the receptacle connector can be disposed within the enclosure at a location that is closer to the distal end than the proximal end. In other examples, the receptacle connector can be disposed within the enclosure at a location that closer to the proximal end than the distal end. In some other examples, the receptacle connector 106 can be disposed behind the user's ear 111, positioning the user's ear between the display portion 103 and the receptacle connector 106.

Some head-mounted displays utilize a re-chargeable power source (e.g., a battery) affixed to the head-mounted display to provide electrical power to the electronic components (e.g., processors, displays, speakers, etc.). The size or capacity of the re-chargeable power source can be limited by the desired size, shape, and weight of the head-mounted display. After the re-chargeable power source has been substantially depleted of electrical power, the user may be required to discontinue use of the head-mounted display to allow re-charging of the electrical power source.

In some aspects of the present disclosure, rather than solely relying on a power source disposed within the head-mounted display (e.g., the first electronic device 100), at least one power source (e.g., the second electronic device 104) can be additionally, or alternatively, electrically coupled to the head-mounted display by a cabled connection (e.g., the cable assembly 102) which electrically couples to the enclosure 108 via the receptacle connector 106. Electrically coupling the power source (e.g., the second electronic device 104) to the receptacle connector 106 within the enclosure 108 of the support 105 can be advantageous. For example, electrical power and/or electrical signals can be provided to the first electronic device 100 while the second electronic device 104 is disposed within a case, pocket, pouch, or otherwise retained by the user. Relocating the electrical power source away from the head-mounted display can accommodate a larger electrical power source than can be directly disposed on the head-mounted display which can provide for extended use of the electronic device 100. Positioning the receptacle connector 106 between the proximal and distal ends 113, 115 of the support 105 can be beneficial in at least partially limiting user contact with the cable assembly 102 by positioning the cable assembly 102 at the side of the user rather than dangling or hanging the cable assembly in front of the user near the head-mounted display.

Electrically coupling a power source (e.g., the second electronic device 104) to the receptacle connector 106 within the enclosure 108, as opposed to disposing the power source directly on the display portion 103 can also enable a reduction in the weight and/or a size of the display portion 103. A reduction in the weight and/or size of the display portion 103 can render the first electronic device 100 more comfortable during use, more convenient to transport, and more convenient to store.

While the receptacle connector 106 and the plug connector 112 are shown in FIGS. 1A and 1B as having a cubic shape or square cross-section, the receptacle connector 106 and the plug connector 112 can define other shapes and cross-sections in other examples. For example, the cross-section of the receptacle connector 106 and the plug connector 112 can be circular or rounded to enable rotation of the plug connector 112 relative to the receptacle connector 106. In other words, the plug connector 112 can be rotatably received within the receptacle connector 106.

FIGS. 2A and 2B show respective side and bottom views of a cable assembly 200 including a plug connector 202 and a shielded cable 204. The plug connector 202 can include a boot 206 and a central protrusion 208. In some examples, the boot 206 can have a circular or semi-circular cross-sectional shape. The plug connector 202 can be centered or substantially centered about a central axis of the circular cross-sectional shape of the boot 206. For example, as shown in FIG. 2A, the central protrusion 208 can be centered about an axis A that extends through a center of the boot 206. The boot 206 can form a cavity or volume and at least a portion of the central protrusion 208 and/or a portion of the shielded cable 204 can be disposed within the volume.

The central protrusion 208 can extend from the boot 206. In some examples, the central protrusion 208 can have a cylindrical shape that enables rotation of the central protrusion 208 within a receptacle connector (e.g., receptacle connector 106). The central protrusion 208 can form an external surface 210 and an internal surface 212. In some examples, the central protrusion 208 can include one or more flanges 214 extending laterally from, or substantially perpendicular to, the external surface 210. In some examples, the central protrusion 208 can form a cavity or volume, for example, the internal surface 212 can form a cavity or volume 216. One or more electrical contacts 218 can be disposed on the internal surface 212, such that the one or more electrical contacts 218 extend into the volume 216 from the internal surface 212. The one or more electrical contacts 218 can define an electrical grounding path, provide electrical power, and/or provide one or more control signals to a receptacle connector.

The shielded cable 204 can be one or more wires (e.g., metallic wires capable of transferring electrical signals and/or electrical power). The one or more wires can be individually shielded or collectively shielded. The shielding can prevent each of the one or more wires from contacting one another. Additionally, or alternatively, the shielding can prevent or limit the influence of electromagnetic waves on each of the one or more wires.

FIG. 2C shows an exploded view of the cable assembly 200 including the boot 206, the shielded cable 204, and the central protrusion 208. The boot 206 can define an aperture 220 and a portion of the shielded cable 204 can extend through the aperture 220. The shielded cable 204 can be adhered, crimped, fastened, or otherwise retained within the boot 206. For example, the shielded cable 204 can include a structure 222 coupled to the shielded cable 204 and positioned within the boot 206 to prevent extraction of the shielded cable 204 from the boot 206. In some examples, the aperture 220 can be formed on a side of the boot 206, such that the shielded cable 204 adjacent the boot 206 can extend parallel or substantially parallel to an enclosure of the electronic device (e.g., the enclosure 108 of the first electronic device 100). As described herein, a user can use the portion of the shielded cable 204 extending from the side of the boot 206 to orient the central protrusion 208 relative to a receptacle connector. For example, using the portion of the shielded cable 204 extending from the side of the boot 206, the user can rotate the central protrusion 208 relative to the receptacle connector to interlock the plug connector 202 to the receptacle connector.

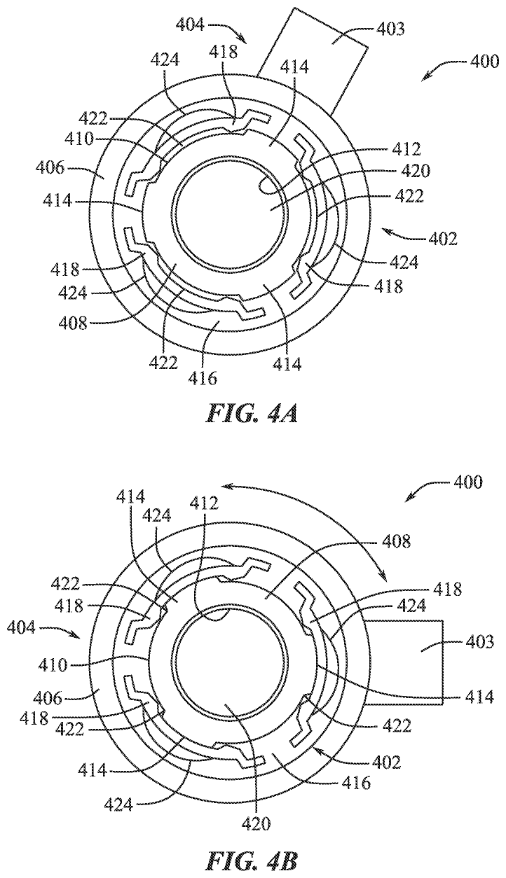

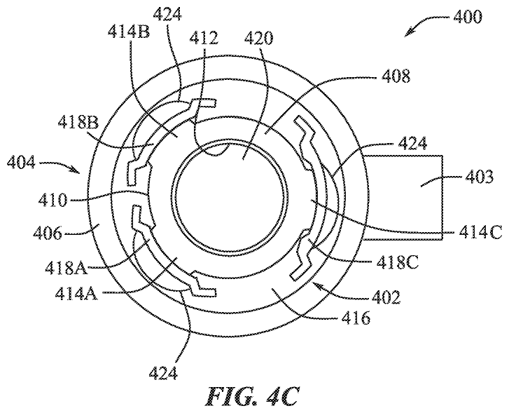

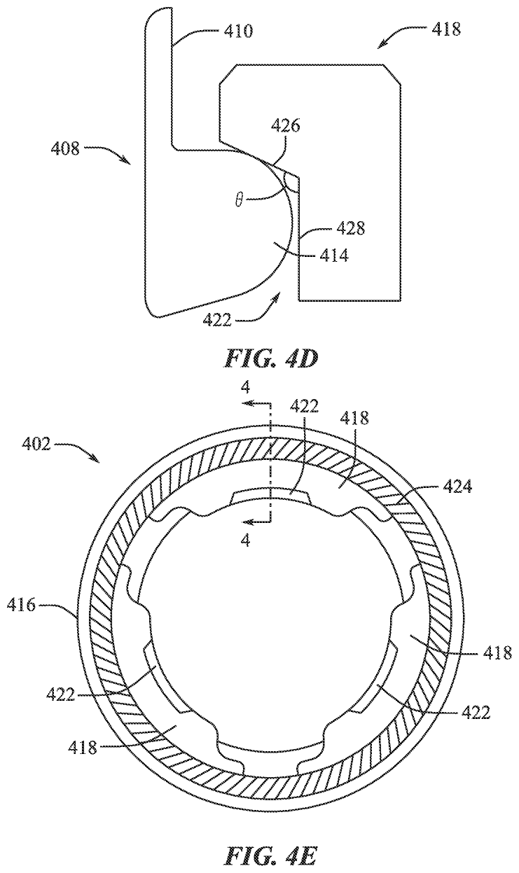

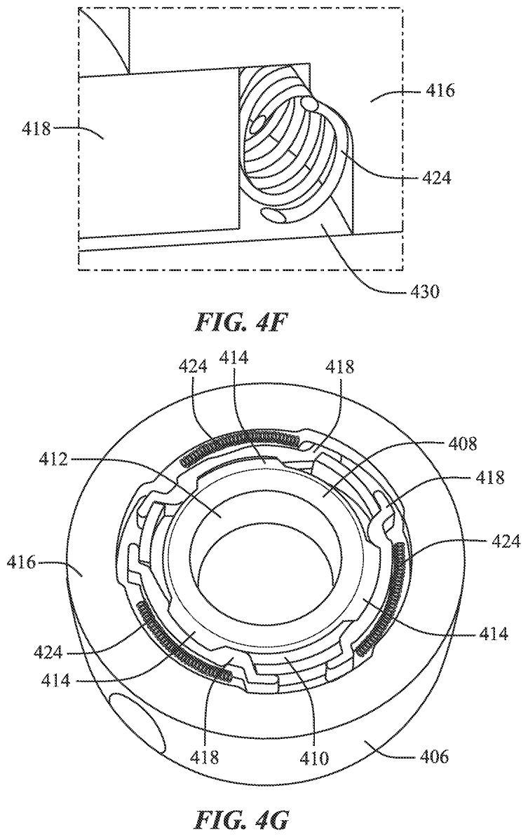

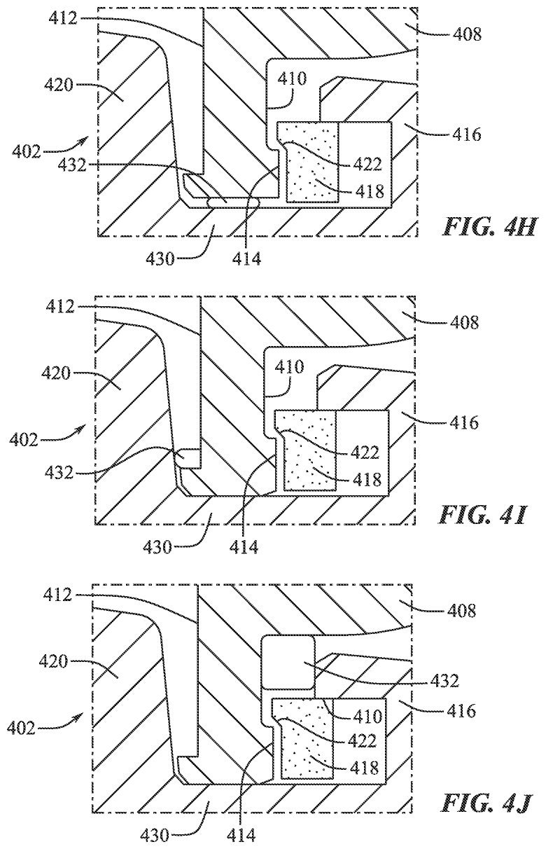

The shielded cable 204 can be affixed to one or more electronic components 224. For example, each individual cable within the shielded cable 204 can be crimped, welded, soldered, adhered, or otherwise affixed to the one or more electronic components 224. In some examples, the one or more electronic components 224 can be a printed circuit board (PCB), a processor, a bus, an amplifier, a rectifier, digital logic circuitry, a signal processing component (e.g., an encoder, decoder, etc.), a combination thereof, or any other electronic component. One or more of the electronic components 224 can electrically couple the shielded cable 204 to the one or more electrical contacts 218. In some examples, the shielded cable 204 can include a support structure 205 which extends along a length of the shielded cable 204. The support structure 205 can be a semi-rigid metal or polymer structure that encircles or at least partially encircles one or more wires 207 of the shielded cable 204. The support structure 205 can prevent the one or more wires 207 disposed within the shielded cable 204 from bending beyond a desirable radius of curvature or otherwise prevent stress cracking within the one or more wires 207 from repetitive bending near the boot 206. For example, a user can repeatedly use a section of the shielded cable 204 nearest the boot 206 to rotate the plug connector 200 relative to a receptacle connector (see FIGS. 4A and 4B). This use can cause stress cracking within the wires 207 or otherwise damage the cable assembly 200. The support structure 205 can prevent the cable assembly 200 from damage associated with repetitive use of the cable assembly 200.

In some examples, the central protrusion 208 can include a first portion 208A and a second portion 208B. The one or more electrical contacts 218 can be affixed to the first portion 208A of the central protrusion 208. For example, each of the one or more electrical contacts 218 can be affixed to the first portion 208A and extend through respective through-holes within the first portion 208A such that at least a portion of each electrical contact 218 extends into the volume 216 formed by the central protrusion 208. In some examples, the one or more electrical contacts 218 can be biased to extend into the volume 216, for example, the one or more electrical contacts 218 can be formed as lever arms which are coupled to the first portion 208A at a proximal end and extend into the volume 216 at a distal end.

In some examples, the first portion 208A can be manufactured from a material that electrically insulates the one or more electrical contacts 218, such that each of the one or more electrical contacts 218 are electrically isolated from one another. The first portion 208A of the central protrusion 208 can be at least partially disposed within the second portion 208B and can form the internal surface 212. For example, the first portion 208A can be fastened, welded, adhered, or otherwise secured within the second portion 208B. In some examples, an electrically insulative material 230 can be disposed between the first and second portions 208A, 208B to isolate the second portion 208B from one or more of the electrical contacts 218.

The second portion 208B of the central protrusion 208 can be coupled to the boot 206, for example, by one or more clips 226 extending from the second portion 208B and interlocking within the boot 206 to retain the central protrusion 208 to the boot 206. In some examples, each of the one or more flanges 214 can extend laterally or perpendicularly from the second portion 208B. Each of the one or more flanges 214 can be radially spaced on the external surface 210. The radial distance between each flange 214 can be equivalent in some examples. In other examples, the radial distance between each flange 214 can be dissimilar, such that the flanges 214 enable insertion of the central protrusion 208 into the receptacle connector (e.g., receptacle connector 106) in a first orientation (see FIGS. 4A and 4B) but prevent insertion of the central protrusion 208 into the receptacle connector in a second orientation.

Similarly, in some examples, a width of each flange 214 can be equivalent in some examples. In other examples, the width of each flange 214 can be dissimilar, such that the flanges 214 enable insertion of the central protrusion 208 into the receptacle connector (e.g., receptacle connector 106) in a first orientation (see FIGS. 4A and 4B) but prevent insertion of the central protrusion 208 into the receptacle connector in a second orientation. For example, the flanges 214 can include a first flange, a second flange, and a third flange. The first flange can have a first width, the second flange can have a second width, and the third flange can have a third width different from the first width and the second width.

In some examples, the second portion 208B can define a recess or channel 228 formed between the one or more flanges 214 and the one or more clips 226. The recess or channel 228 can provide additional clearance to accommodate one or more components within the receptacle connector, for example, one or more detents within the receptacle connector (see FIGS. 3A-3C). While the example second portion 208B shown in FIGS. 2A-2C has three distinct flanges 214, other examples can have more or fewer flanges 214, such as, a single flange 214, two, three, four, or more than four flanges 214. Similarly, while the example first portion 208A shown in FIGS. 2A-2C has six distinct electrical contacts 218, other examples can have more or fewer electrical contacts 218, such as, a single electrical contact 218, two, three, four, five, six, or more than six electrical contacts 218.

FIGS. 3A and 3B show a perspective view and a top view of a receptacle connector 300 disposed on an enclosure 302 of an electronic device (e.g., the first electronic device 100). In some examples, the receptacle connector 300 can be disposed on or within the enclosure 302, such that a trim ring 304 of the receptacle connector 300 is at least partially disposed within the enclosure 302. Alternatively, the trim ring 304 can be disposed on or within the enclosure 302 such that the trim ring 304 is flush with an exterior surface 306 of the enclosure 302.

In some examples, the receptacle connector 300 can include the trim ring 304, a base 308, one or more detents 310, and a raised portion 312. The trim ring 304 can couple to the base 308 to form a recess 314 and one or more undercut regions 316 at a periphery of the recess 314. Each of the one or more undercut regions can house or retain a respective detent 310 of the one or more detents 310. While a central protrusion (e.g., central protrusion 208) is disposed within the recess 314, a flange (e.g., the one or more flanges 214) can extend into a channel 317 defined by the detent 310 of the one or more detents 310 (see FIG. 4B). In some examples, each detent 310 of the one or more detents 310 can be biased toward the raised portion 312 by a biasing element (see leaf springs 324). In other words, each detent 310 can radially translate within their respective undercut regions 316 toward and away from the raised portion 312.

In some examples, the raised portion 312 can be disposed in the center of the recess 314, such that the recess 314 forms a ring within the receptacle connector 300. The raised portion 312 can be a distinct component of the receptacle connector 300. For example, the raised portion 312 can be adhered, fastened, interlocked, welded, or otherwise coupled to the base 308. In some examples, one or more electrical contacts 318 can be disposed on the raised portion 312. Each of the one or more electrical contacts 318 can physically contact one or more electrical contacts of the plug connector (e.g., electrical contacts 218) when the plug connector is coupled to the receptacle connector 300.

FIG. 3C shows an exploded view of the receptacle connector 300 including the trim ring 304, a mounting ring 320, one or more detents 310, the raised portion 312, the base 308, and an adhesive layer 322. The mounting ring 320 can affix the receptacle connector 300 to the enclosure 302. For example, the mounting ring 320 can be coupled to the enclosure 302 and at least one of the trim ring 304 and the base 308. The mounting ring 320 can be affixed to the enclosure 302 by adhesives, adhesive tapes, fasteners, welding, a combination thereof, or any other mechanism from permanently or temporarily securing the mounting ring 320 to the enclosure 302. Additionally, or alternatively, the adhesive layer 322 can affix the receptacle connector 300 to the enclosure 302. For example, the adhesive layer 322 can be a pressure sensitive adhesive (PSA) tape disposed between the base 308 and the enclosure 302 or another component disposed within the enclosure 302, such as, a printed circuit board (PCB) or other component.

In some examples, each detent 310 of the one or more detents 310 can be biased toward the raised portion 312, for example, by a leaf spring 324 disposed within the undercut region 316 and positioned between the trim ring 304 and the detent 310. While one or more leaf springs 324 are shown in FIG. 3C, one or more of the detents 310 can be biased toward the raised portion 312 by another type of biasing element (e.g., a coiled spring, an elastic foam, etc.). The biasing elements, such as leaf springs and canted coil springs, will be discussed in further detail herein with reference to FIGS. 4A-4G.

In some examples, the raised portion 312 can include a body 326 and a cap 328. In some examples, the body 326 can be manufactured from a material that electrically insulates the one or more electrical contacts 318, such that each of the one or more electrical contacts 318 are electrically isolated from one another. For example, each of the one or more electrical contacts 318 can be at least partially disposed within a respective through-hole defined within the body 326. The cap 328 can be coupled to the body 326.

FIG. 3D details an example arrangement of the electrical contacts 318 disposed radially about the body 326 of the raised portion 312. While the electrical contacts 318 shown in FIG. 3D are disposed about the body 326 of the raised portion 312, the electrical contacts 318 can be additionally, or alternatively, disposed on the cap 328 of the raised portion 312. For example, the cap 328 itself can form a grounding path for one or more electrical contacts of the plug connector. In some examples, one or more of the electrical contacts 318 can be broad or wide enough to enable two separate electrical contacts 218 of the plug connector 202 to physically contact the single electrical contact 318 (see electrical contact 318B in FIG. 3E). In some examples, one or more of the electrical contacts 318 can be relatively narrow, such that only one electrical contact 218 of the plug connector 202 can physically contact the single electrical contact 318 (see electrical contact 318A in FIG. 3E).

Each of the one or more electrical contacts 318 can provide an electrical grounding path, an electrical power path, an electrical signals path, or a combination thereof. For example, one or more of the electrical contacts 318 can provide a grounding path, such that one or more of the electrical contacts 218 of the plug connector 202 is electrically grounded when touching the one or more electrical contacts 318. Alternatively, or additionally, one or more of the electrical contacts 318 can enable one or more electrical signals to pass between the receptacle connector 300 and the plug connector 202 when one or more of the electrical contacts 218 of the plug connector 202 are touching or contacting the one or more electrical contacts 318. Alternatively, or additionally, one or more of the electrical contacts 318 can enable transfer of electrical power between the receptacle connector 300 and the plug connector 202 when one or more of the electrical contacts 218 of the plug connector 202 are touching or contacting the one or more electrical contacts 318. In some examples, one or more of the electrical contacts 318 can detect when the plug connector 202 has become uncoupled or is uncoupling from the receptacle connector 300. This detection can be critical as an unexpected and abrupt loss of power can damage electrical components within the electronic device (e.g., first electronic device 100) and/or result in the loss of data. Detection of the plug connector 202 decoupling from the receptacle connector 300 will be described in more detail below with reference to FIG. 3E.

FIG. 3E shows the cable assembly 200, including the plug connector 202 and the shielded cable 204, being pulled away from the receptacle connector 300. The plug connector 202 can be unintentionally and abruptly extracted from the receptacle connector 300, for example, when the shielded cable 204 snags on an object and pulls the plug connector 202 in a direction away from the receptacle connector 300 (as represented by the arrow shown in FIG. 3E). When the plug connector 202 is abruptly and/or undesirably extracted from the receptacle connector 300, the electrical contacts 218 of the plug connector 202 can be pulled out of contact with the correlating electrical contacts 318 of the receptacle connector causing a loss of: electrical power, control signals, an electrical ground, or a combination thereof. An abrupt loss of electrical power, electrical ground, or one or more control signals can damage the electronic device and/or compromise or corrupt information stored on the electronic device.

In some examples, at least one of the electrical contacts (e.g., electrical contact 318A) within the receptacle connector 300 can detect when the plug connector 202 is being removed from the receptacle connector 300. For example, the electronic device can detect an undesirable extraction of the plug connector 202 from the receptacle connector 300 when the electrical contact 218A of the plug connector 202 is pulled out of contact with the electrical contact 318A of the receptacle connector 300. An undesirable extraction of the plug connector 202 from the receptacle connector 300 can occur when the plug connector 202 is pulled away from the receptacle connector 300 from the side of the plug connector 202 where the shielded cable 204 enters the boot 206. This undesirable extraction scenario can be most probable as the shielded cable 204 can get snagged on an object and caused to pull the plug connector 202 away from the receptacle connector 300 (as illustrated by the arrow).

In some examples, the one or more electrical contacts 318 can be disposed about the raised portion 312 such that the electrical contact 218A moves out of contact from the electrical contact 318A before the electrical contacts 218B of the plug connector 202 move out of contact with the electrical contact 318B of the receptacle connector 300. While the electrical contact 218A is out of contact from the electrical contact 318A but before the electrical contacts 218B of the plug connector 202 move out of contact with the electrical contact 318B of the receptacle connector 300, a duration of time can pass. The duration of time can be sufficient to enable the electronic device to mitigate any destructive effects of unintentionally extracting the plug connector 202 from the receptacle connector 300. The size, shape, and position of each of the electrical contacts 218, 318 can impact the duration of time when the electrical contact 218A is out of contact from the electrical contact 318A but before the electrical contacts 218B move out of contact with the electrical contact 318B.

In some examples, a contact area defined by the electrical contact 318A (e.g., a surface area of the electrical contact 318 that can be engaged by one or more of the electrical contacts 218) can be different from a contact area defined by the electrical contact 318B. In other words, each electrical contact 318A, 318B can be sized or shaped such that one or more correlating electrical contacts 218 can physically contact the contact area defined by each respective electrical contact 318. As shown in FIGS. 3D and 3E, the contact area of the electrical contact 318B can be larger than the contact area of the electrical contact 318A. As such, the electrical contact 318B can interface with more than one corresponding electrical contacts 218B while the plug connector 200 is inserted into the receptacle connector 300. The size, shape, and position of the contact area of each electrical contact 218, 318 can impact the duration of time when the electrical contact 218A is out of contact from the electrical contact 318A but before the electrical contacts 218B move out of contact with the electrical contact 318B.

A loss of the electrical signal passed between the electrical contacts 218A, 318A can alert the electronic device (e.g., a processor of the electronic device) that an unexpected or undesirable extraction of the plug connector 202 is occurring. Accordingly, the electronic device can react to the loss of signal by implementing one or more actions to safeguard the electrical components and information of the electronic device. For example, a processor within the electronic device can: withdraw electrical power from one or more electronic components, cause data to be saved, or perform another preventative task or action. While FIG. 3E shows the plug connector 202 being extracted from the receptacle connector 300 from the side of the plug connector 202 adjacent the shielded cable 204 (e.g., rocking out of the receptacle connector 300 starting from the side of the plug connector 202 adjacent the shielded cable 204), the plug connector 202 can be undesirably detached from another side of the plug connector 202 in other examples.

Any number or variety of components in any of the configurations described herein can be included in the electronic device. The components can include any combination of the features described herein and can be arranged in any of the various configurations described herein. The structure and arrangement of components of an electronic device having an enclosure and receptacle connector with structures described herein, and defining an internal volume, as well as the concepts regarding various detents and biasing elements, can apply not only to the specific examples discussed herein, but to any number of examples in any combination. Examples of detents and other retaining mechanisms within the receptacle connector of an electronic device are described below, with reference to FIGS. 4A-4J.

FIG. 4A shows a portion of a cable assembly 400 being inserted into a receptacle connector 402. The cable assembly 400 can be substantially similar to, and can include some or all of, the features of the cable assemblies 102, 200. For example, the cable assembly 400 can include a shielded cable 403 and a plug connector 404 having a boot 406 and a central protrusion 408. The central protrusion 408 can form an external surface 410 and an internal surface 412. In some examples, the central protrusion 408 can include one or more flanges 414 extending laterally from, or substantially perpendicular to, the external surface 410. In some examples, the central protrusion 408 can form a cavity or volume, for example, the internal surface 412 can form a cavity or volume.

The receptacle connector 402 can be substantially similar to, and can include some or all of, the features of the receptacle connectors 106, 300. For example, the receptacle connector 402 can include a trim ring 416, one or more detents 418, and a raised portion 420. The trim ring 416 can form one or more undercut regions which house or retain a respective detent 418 of the one or more detents 418. While a central protrusion 408 is disposed within the receptacle connector 402, the one or more flanges 414 can extend into respective channels 422 defined by a detent 418 of the one or more detents 418 (see FIG. 4B). In some examples, each detent 418 of the one or more detents 418 can be biased toward the raised portion 420 by a biasing element 424. In other words, each detent 418 can radially translate within their respective undercut regions toward and away from the raised portion 420 to engage and disengage with a respective flange 414.

FIG. 4A shows the raised portion 420 of the plug connector 404 inserted into the receptacle connector 402. When first inserted, the flanges 414 can be disposed between the detents 418. In some examples, the central protrusion 408 can only be inserted into the receptacle connector 402 in a particular orientation because the flanges 414 have a particular size, shape, and or spacing which only permits insertion of the flanges 414 between the detents 418 while the plug connector 404 is in a particular orientation relative to the receptacle connector 402. In some examples, one or more of the flanges 414 can minimally contact one or more of the detents 418 when the central protrusion 408 is inserted into the receptacle connector 402 such that a force is required to overcome the minimal contact to insert the central protrusion 408 into the receptacle connector 402 to a depth that enables or allows rotation of the central protrusion 408 (see FIG. 4B). For example, the force required to insert the central protrusion 408 into the receptacle connector 402 can be at least 0.05 Nm, between about 0.05 Nm and about 0.075 Nm, between about 0.075 Nm and about 0.1 Nm, between about 0.1 Nm and about 0.125 Nm, between about 0.125 Nm and about 0.15 Nm, or greater than 0.15 Nm.

After insertion of the raised portion 420 into the receptacle connector 402, the plug connector 404 can be rotated to cause each respective flange 414 to radially translate into a respective channel 422 defined by each of the detents 418. FIG. 4B shows each respective flange 414 rotated into a respective channel 422 defined by each of the detents 418. While the flanges 414 are disposed between the detents 418 (see FIG. 4A), a relatively lesser force can be required to withdraw or extract the plug connector 404 from the receptacle connector 402. For example, the force required to withdraw the central protrusion 408 from the receptacle connector 402 while the flanges 414 are disposed between the detents 418 (see FIG. 4A) can be at least 0.25 Nm, between about 0.25 Nm and about 0.5 Nm, between about 0.5 Nm and about 0.75 Nm, between about 0.75 Nm and about 1 Nm, between about 1 Nm and about 1.25 Nm, or greater than 1.25 Nm.

While the flanges 414 are received within respective channels 422 (see FIG. 4B), a relatively greater force can be required to withdraw or extract the plug connector 404 from the receptacle connector 402. For example, the force required to withdraw the central protrusion 408 from the receptacle connector 402 while the flanges 414 are received within respective channels 422 (see FIG. 4B) can be at least 1.5 Nm, between about 1.5 Nm and about 2.25 Nm, between about 2.25 Nm and about 2.5 Nm, between about 2.5 Nm and about 2.75 Nm, between about 2.75 Nm and about 3 Nm, or greater than 3 Nm. The force required to withdraw the central protrusion 408 from the receptacle connector 402 while the flanges 414 are received within respective channels 422 can be at least partially based on the force applied on the shielded cable 403 (e.g., force applied on the shielded cable 403 by snagging on an object). Additionally, or alternatively, the force required to withdraw the central protrusion 408 from the receptacle connector 402 while the flanges 414 are received within respective channels 422 can be at least partially based on a direction the force is applied (e.g., the orientation of the cable assembly 400 relative to the receptacle connector 402). For example, one of the biasing elements 424 can have a relatively high spring constant which requires a relatively higher application of force to move the correlating detent 418 and release the correlating flange 414.

In some examples, the central protrusion 408 can be rotatable within a recess formed by the receptacle connector 402 in a first direction more than about 15 degrees (e.g., between 15 degrees and 60 degrees). Additionally, or alternatively, the central protrusion 408 can be prevented or inhibited from rotating within the recess in a second direction more than 15 degrees (e.g., between 1 degree and 15 degrees). For example, the central protrusion 408 can be rotated clockwise about 30 degrees From the orientation shown in FIG. 4A to interlock the plug connector 404 and the receptacle connector 4020 (see FIG. 4B) and the central protrusion 408 can be prevented or inhibited from rotating counter-clockwise more than about 10 degrees From the orientation shown in FIG. 4A.

FIG. 4C shows another configuration of the raised portion 420 of the plug connector 404 inserted into the receptacle connector 402. More specifically, FIG. 4C shows a configuration wherein the flanges 414 (e.g., 414A, 414B, 414C) are not equidistantly spaced around the central protrusion 408. For example, a radial distance between the flange 414A and the flange 414C can be larger than a radial distance between the flange 414A and the flange 414B. Similarly, a radial distance between the flange 414B and the flange 414C can be larger than a radial distance between the flange 414A and the flange 414B. In some examples, the radial spacing between one or more of the flanges 414A, 414B, 414C can be dissimilar, such that, the central protrusion 408 can only be inserted into the receptacle connector 402 in a particular orientation and prevented from being inserted into the receptacle connector 402 in unwanted or undesirable orientations (i.e., orientations that would align non-correlating electrical contacts).

Additionally, or alternatively, a width, a depth, a thickness, or any other size parameter of one of the flanges 414A, 414B, 414C can be comparatively dissimilar to one or more of the other flanges 414A, 414B, 414C to prevent the plug connector 404 from being coupled to the receptacle connector 402 in an undesirable orientation. The detent 418A, 418B, 418C correlating to each of the flanges 414A, 414B, 414C can be sized and shaped to at least partially receive only the correlating flange (e.g., receive within the channel 422) due to a unique width, depth, thickness, or size parameter of the correlating flange. For example, the combination of size and shape of the flange 414A can be unique to prevent the flange 414A from being coupled with any other detent except the detent 418A. In other words, the size and shape of the flanges 414A, 414B, 414C and/or the size and shape of the detents 418A, 418B, 418C can prevent the central protrusion 408 from being inserted and rotated within the receptacle connector 402 in an undesirable configuration (i.e., configurations that would align non-correlating electrical contacts).

FIG. 4D shows a cross-sectional view of one of the flanges 414 disposed within the channel 422 and interfacing one of the detents 418. In some examples, the detent 418 can define the channel 422 such that a first surface 426 of the channel 422 is angled relative to a second surface 428 of the channel 422 to form an angle Θ. The flange 414 can engage or contact the first surface 426 while disposed within the channel 422 (see FIG. 4B). The angle Θ can directly correlate to a force required to overcome the biasing element 424 to cause the detent 418 to move away from the central protrusion 408 and enable extraction of the flange 414 from the channel 422 (i.e., enable extraction of the plug connector 404 from the receptacle connector 402). For example, a relatively smaller angle Θ can require a relatively greater force to extract the plug connector 404 from the receptacle connector 402.

Alternatively, a relatively larger angle Θ can require relatively smaller force to extract the plug connector 404 from the receptacle connector 402. The angle Θ can be about 30 degrees, between about 30 degrees and about 60 degrees, between about 60 degrees and about 90 degrees, between about 90 degrees and about 120 degrees, between about 120 degrees and about 150 degrees, between about 150 degrees and about 180 degrees, or less than 180 degrees.

Each respective detent 418 can form a respective angle Θ. In some examples, one or more of the detents 418 can have similar or substantially similar angles Θ. In some examples, one or more of the detents 418 can have a different angle Θ than another detent 418. In these examples, the plug connector 404 can be easier to extract from the receptacle connector 402 if lifted from a side of the boot 406 near the detent 418 having a relatively greater angle Θ. Alternatively, the plug connector 404 can be more difficult to extract (i.e., require more extraction force) from the receptacle connector 402 if lifted from a side of the boot 406 near the detent 418 having a relatively smaller angle Θ. Additionally, or alternatively, the portion of the flange 414 that interfaces the channel 422 can be angled to provide the same technical advantages as described above related to the angle Θ and the channel 422.

FIG. 4E shows an example of the receptacle connector 402 wherein the biasing element 424 is a canted coil spring disposed between the detents 418 and the trim ring 416 of the receptacle connector 402. The biasing element 424 can compress or otherwise elastically deform to allow the detents 418 to translate during rotation of the plug connector 404 (see FIG. 4B). After rotation, the biasing element 424 can decompress or otherwise expand to bias the detents 418 toward the flanges 414. FIG. 4F shows a cross-sectional view of the biasing element 424 disposed within the undercut region of the trim ring 416. A combination of the trim ring 416, the detents 418, and a base 430 (e.g., base 308) of the receptacle connector 402 can trap or retain the biasing element 424 within the receptacle connector 402. In other words, the biasing element 424 can free-float within the receptacle connector without be affixed to a particular component of the receptacle connector 402.

FIG. 4G shows an example of the receptacle connector 402 wherein the biasing element 424 includes discrete sections of a canted coil spring, each section being disposed adjacent a respective detent 418 and the trim ring 416 of the receptacle connector 402. Each respective section of the biasing element 424 can independently compress or otherwise elastically deform to allow each respective detent 418 to translate during rotation of the plug connector 404 (see FIG. 4B). After rotation, each respective section of the biasing element 424 can decompress or otherwise expand to bias the respective detent 418 toward the flange 414. Each biasing element 424 (i.e., each discrete section of canted coil spring) can have various spring rates, coil rates, wire gauges, diameters, lengths, and other attributes which enable independent or distinct retention characteristics between each detent 418 and each flange 414. In other words, the attributes of each section of canted coil spring can be independently varied to customize a force required to extract the respective flange 414 from the respective channel 422. This can be particularly beneficial to increase a force the detent 418 applies to the respective flange 414 nearest the shielded cable 403 because the shielded cable 403 can accidentally snag or tangle on an object and apply an undesirable extraction force on the plug connector 404 (see FIG. 3E).

FIGS. 4H-4J show a cross-sectional side view of the central flange 408 disposed within the receptacle connector 402 and the flange 414 engaging the channel 422 of the detent 418. FIGS. 4H-4J also show a seal 432 disposed between the central protrusion 408 and the receptacle connector 402 at various locations to prevent ingress of contaminants into the receptacle connector 402, such as, fluids, dust, liquids, and other materials that can degrade or impede the functionality of the plug connector 404 and the receptacle connector 402. The seal 432 can be affixed to any surface of the plug connector 404 and/or the receptacle connector 402. For example, the seal 432 can be molded, adhered, welded, fastened, or otherwise secured to a surface of the plug connector 404 and/or the receptacle connector 402.

FIG. 4H shows the seal 432 disposed between the base 430 and the central protrusion 408. FIG. 4I shows the seal 432 disposed between the raised portion 420 and the internal surface 412 of the central protrusion 408. FIG. 4J shows the seal 432 disposed between the trim ring 416 and the external surface 410 of the central protrusion 408. While

FIGS. 4I-4J only depict a single seal 432 disposed between the central protrusion 408 and the receptacle connector 402, other examples can have multiple seals 432, each disposed at one of a plurality of positions within the receptacle connector 402. Additionally, alternatively, one or more seals 432 can be affixed or otherwise secured to the central protrusion 408.

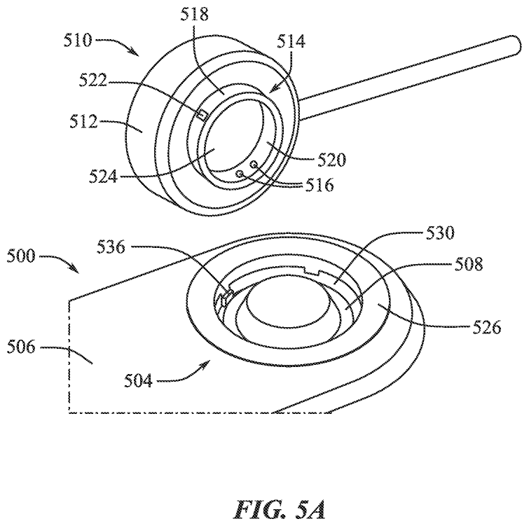

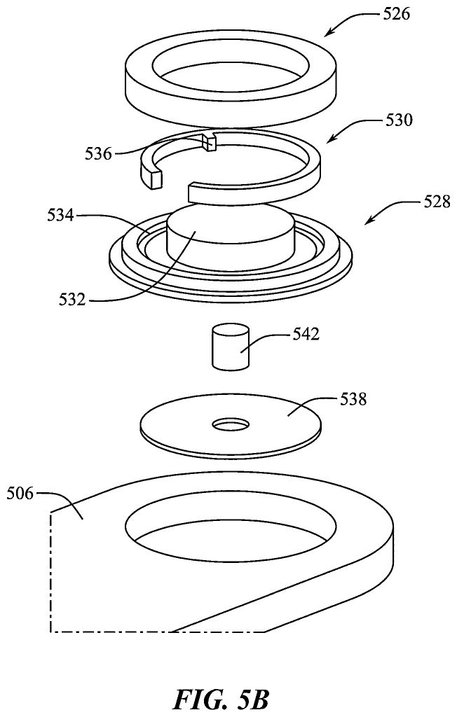

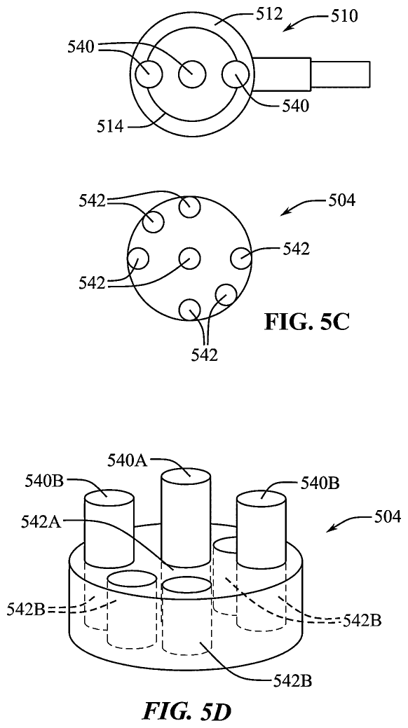

Any number or variety of components in any of the configurations described herein can be included in the electronic device. The components can include any combination of the features described herein and can be arranged in any of the various configurations described herein. The structure and arrangement of components of an electronic device having an enclosure and receptacle connector with structures described herein, and defining an internal volume, as well as the concepts regarding a detent ring and magnets, can apply not only to the specific examples discussed herein, but to any number of examples in any combination. Examples of a detent ring and other retaining mechanisms within the receptacle connector of an electronic device are described below, with reference to FIGS. 5A-5D.

FIG. 5A-5B show an electronic device 500 and a cable assembly 502. The electronic device 500 can include a receptacle connector 504 disposed on or within an enclosure 506 of the electronic device 500. The receptacle connector 504 can form a recess 508 that can receive a portion of the cable assembly 502. The cable assembly 502 can include a plug connector 510 at a distal end of the cable assembly 502. The plug connector 510 can include a boot 512 and a central protrusion 514 at least partially disposed within the boot 512. The central protrusion 514 can include one or more electrical contacts 516 that electrically couple the plug connector 510 to the electronic device 500. The central protrusion 514 can form an external surface 518 and an internal surface 520. In some examples, the central protrusion 514 can include one or more recesses 522 extending laterally within and substantially perpendicular to, the external surface 518. In some examples, the central protrusion 514 can form a cavity or volume, for example, the internal surface 520 can form a cavity or volume 524. The one or more electrical contacts 516 can be disposed on the internal surface 520, such that the one or more electrical contacts 516 extend into the volume 524 from the internal surface 520.

In some examples, the receptacle connector 504 can include the trim ring 526, a base 528, a detent ring 530, and a raised portion 532. The base 528 can form an undercut region 534 housing or retaining the detent ring 530. The detent ring 530 can include one or more flanges 536 that extend toward the raised portion 532. While the central protrusion 514 is disposed within receptacle connector 504, each of the one or more flanges 536 can extend into a respective recess 522 formed in the central protrusion 514. In some examples, the detent ring 530 can be biased, such that the one or more flanges 536 are biased to extend into the recess 522 while the plug connector 510 is coupled to the receptacle connector 504.

In some examples, the raised portion 532 can be disposed in the center of the receptacle connector 504, such that the space between the trim ring 526 and the raised portion 532 forms a ring within the receptacle connector 504. In some examples, one or more electrical contacts (not shown) can be disposed on the raised portion 532. Each of the one or more electrical contacts (see FIG. 3D) can physically contact one or more electrical contacts 516 of the plug connector 510 when the plug connector 510 is coupled to the receptacle connector 504.

The receptacle connector 504 can be affixed to the enclosure 506 by adhesives, adhesive tapes, fasteners, welding, a combination thereof, or any other mechanism from permanently or temporarily securing the receptacle connector 504 to the enclosure 506. Additionally, or alternatively, an adhesive layer 538 can affix the receptacle connector 504 to the enclosure 506. For example, the adhesive layer 538 can be a pressure sensitive adhesive (PSA) tape disposed between the base 528 and the enclosure 506 or another component disposed within the enclosure 506, such as, a printed circuit board (PCB) or other component.

As shown in FIG. 5C, in some examples, the plug connector 510 can include one or more magnets 540. For example, the one or more magnets 540 can be disposed within the boot 512, the central protrusion 514, or a combination thereof. The one or more magnets 540 can generate a magnetic field that retains or orients the plug connector 510 relative to one or more magnets 542 disposed within the receptacle connector 504. FIG. 5D shows the magnets 540 disposed within the plug connector 510 positioned adjacent or above the magnets 542 disposed within the receptacle connector 504. While the central protrusion 514 is disposed within the receptacle connector 504, the inner or central magnet 540A can remain oriented adjacent or above the inner or central magnet 542B even if the plug connector 510 is rotated relative to the receptacle connector 504. As the plug connector 510 is rotated relative to the receptacle connector 504, the offset or peripheral magnets 540B can radially translate to align with one of the offset or peripheral magnets 542B within the receptacle connector 504 to retain and/or orient the plug connector 510 relative to the receptacle connector 504. One or more of the magnets 540, 542 can be positioned such that one or more of the magnets oppose a particular orientation of the plug connector 510 relative to the receptacle connector 504. For example, opposing magnetic forces can be generated to prevent the plug connector 510 from interlocking with the receptacle connector 504 in an undesirable or inoperable orientation (e.g., an orientation having the electrical contacts misaligned and/or the channels and flanges misaligned).

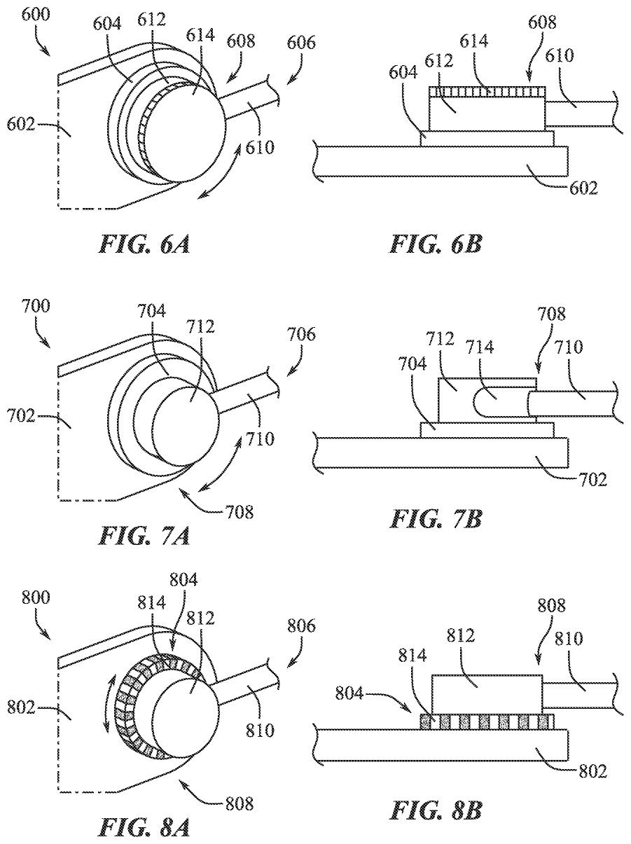

Any number or variety of components in any of the configurations described herein can be included in the electronic device. The components can include any combination of the features described herein and can be arranged in any of the various configurations described herein. The structure and arrangement of the cable assembly and plug connector, as well as the concepts regarding interlocking the plug connector to a receptacle connector, can apply not only to the specific examples discussed herein, but to any number of examples in any combination. Examples of interlocking a plug connector to a receptacle connector of an electronic device are described below, with reference to FIGS. 6A-8E.

FIGS. 6A and 6B show an electronic device 600 including an enclosure 602 and a receptacle connector 604 disposed on the enclosure 602. A cable assembly 606, including a plug connector 608 and a shielded cable 610, can be operably coupled to the receptacle connector 604. The plug connector 608 can include a boot 612 and a central protrusion (not shown, see central protrusions 116, 208, 408, 514). The central protrusion can interlock within the receptacle connector 604 to affix the plug connector 608 to the electronic device 600.

In some examples, one or more of the components of the plug connector 608 can be rotated to interlock or disengage the plug connector 608 and the receptacle connector 604. For example, the plug connector 608 can include a cap 614 disposed adjacent the boot 612. The cap 614 can be rotated in a first direction (illustrated in FIG. 6A with an arrow) to interlock the plug connector 608 to the receptacle connector 604 and rotated in a second direction to disengage the plug connector 608 from the receptacle connector 604. In some examples, only the cap 614 is rotated to interlock/disengage the plug connector 608 and the receptacle connector 604 while the boot 612 and the shielded cable 610 remain in a fixed position.

FIGS. 7A and 7B show an electronic device 700 including an enclosure 702 and a receptacle connector 704 disposed on the enclosure 702. A cable assembly 706, including a plug connector 708 and a shielded cable 710, can be operably coupled to the receptacle connector 704. The plug connector 708 can include a boot 712 and a central protrusion (not shown, see central protrusions 116, 208, 408, 514). The central protrusion can interlock within the receptacle connector 704 to affix the plug connector 708 to the electronic device 700.

In some examples, one or more of the components of the plug connector 708 can be rotated to interlock or disengage the plug connector 608 and the receptacle connector 604. For example, the boot 712 can be rotated in a first direction (illustrated in FIG. 7A with an arrow) to interlock the plug connector 708 to the receptacle connector 704 and rotated in a second direction to disengage the plug connector 708 from the receptacle connector 704. In some examples, only the boot 712 is rotated to interlock/disengage the plug connector 708 and the receptacle connector 704 while the shielded cable 710 remains in a fixed position. For example, the boot 712 can define a slot 714 that enables the boot 712 to rotate while the shielded cable 710 adjacent the boot 712 remains in a fixed position relative to the enclosure 702.

FIGS. 8A and 8B show an electronic device 800 including an enclosure 802 and a receptacle connector 804 disposed on the enclosure 802. A cable assembly 806, including a plug connector 808 and a shielded cable 810, can be operably coupled to the receptacle connector 804. The plug connector 808 can include a boot 812 and a central protrusion (not shown, see central protrusions 116, 208, 408, 514). The central protrusion can interlock within the receptacle connector 804 to affix the plug connector 808 to the electronic device 800.

In some examples, one or more of the components of the receptacle connector 804 can be rotated to interlock or disengage the plug connector 808 and the receptacle connector 804. For example, the receptacle connector 804 can include a ring 814 disposed adjacent the enclosure 802. The ring 814 can be rotated in a first direction (illustrated in FIG. 8A with an arrow) to interlock the plug connector 808 to the receptacle connector 804 and rotated in a second direction to disengage the plug connector 808 from the receptacle connector 804. In some examples, only the ring 814 is rotated to interlock/disengage the plug connector 808 and the receptacle connector 804 while the plug connector 808 remains in a fixed position relative to the enclosure 802.

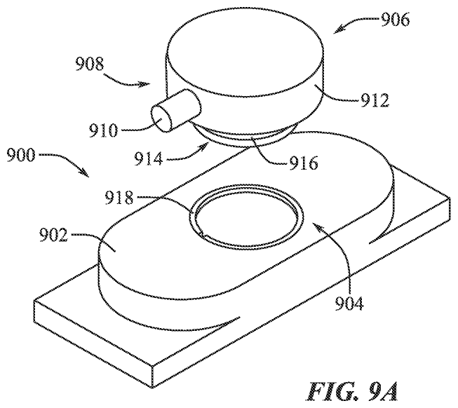

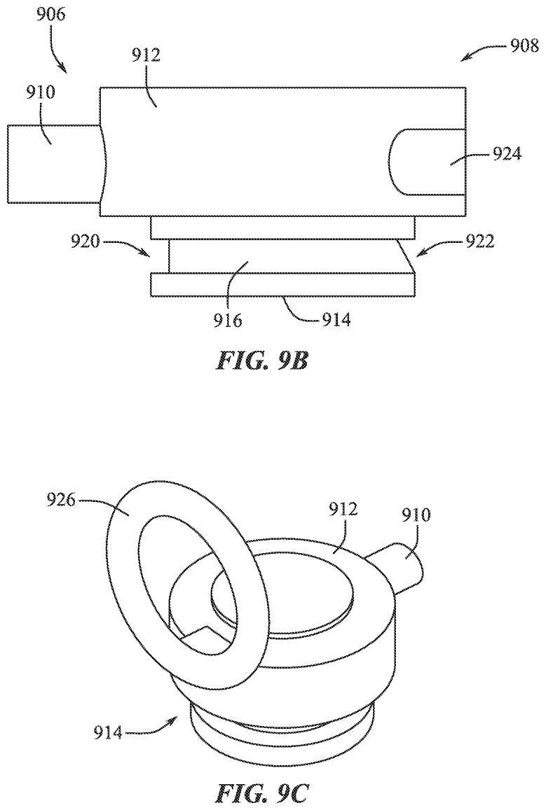

Any number or variety of components in any of the configurations described herein can be included in the electronic device. The components can include any combination of the features described herein and can be arranged in any of the various configurations described herein. The structure and arrangement of components of an electronic device having an enclosure and receptacle connector with structures described herein, and defining an internal volume, as well as the concepts regarding a detent ring, can apply not only to the specific examples discussed herein, but to any number of examples in any combination. Examples of a detent ring and other retaining mechanisms within the receptacle connector of an electronic device are described below, with reference to FIGS. 9A-9C.

FIG. 9A shows an electronic device 900 including an enclosure 902 and a receptacle connector 904 disposed on the enclosure 902. A cable assembly 906, including a plug connector 908 and a shielded cable 910, can be operably coupled to the receptacle connector 904. The plug connector 908 can include a boot 912 and a central protrusion 914. The central protrusion 914 can interlock within the receptacle connector 904 to affix the plug connector 908 to the electronic device 900. For example, the central protrusion 914 can form a channel 916 which interlocks with a detent ring 918 disposed within the receptacle connector 904.

As shown in FIG. 9B, a first portion 920 of the channel 916 can be defined by surfaces which are perpendicular to one another and therefore inhibit the first portion 920 from being pulled out of contact with the detent ring 918. Conversely, a second portion 922 of the channel 916 can be defined by surfaces which are not perpendicular to one another and therefore enable the second portion 922 to be pulled out of contact with the detent ring 918 with relatively less force. In other words, the interface between the first portion 920 of the channel 916 and the detent ring 918 can limit accidental or unwanted extraction of the plug connector 908 from the receptacle connector 904 (e.g., snagging the shielded cable 910) by requiring a greater extraction force. Conversely, the sloped or slanted interface between the second portion 922 of the channel 916 and the detent ring 918 can enable intentional extraction of the plug connector 908 from the receptacle connector 904 (e.g., prying or lifting the plug connector 908 via a recess 924 in the boot 912).

In some examples, the cable assembly 906 can have one or more components that allow a user to interface with the plug connector 908 to remove the plug connector 908 from the receptacle connector 904. For example, the boot 912 can form an indent or recess 924 which allows the user to pry or lift the plug connector 908 away from the receptacle connector 904. In some examples, the position of the recess 924 on the boot 912 can coincide with the second portion 922 of the channel 916 to enable the user to pry the plug connector 908 from the receptacle connector 904 with relatively less force. Additionally or alternatively, as shown in FIG. 9C, the plug connector 908 can include a loop 926 coupled to the plug connector 908 that enables the user to pull the plug connector 908 away from the receptacle connector 904. In some examples, the position of the loop 926 on the plug connector 908 can coincide with the second portion 922 of the channel 916 to enable the user to pull the plug connector 908 from the receptacle connector 904 with relatively less force.

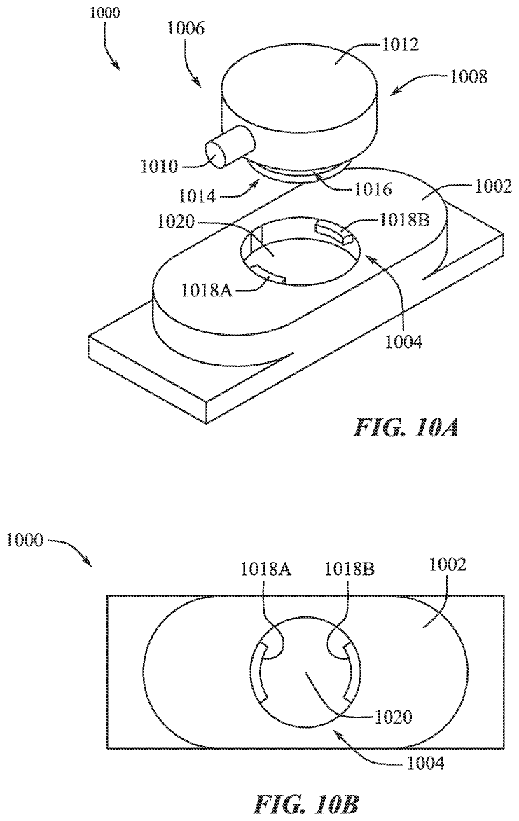

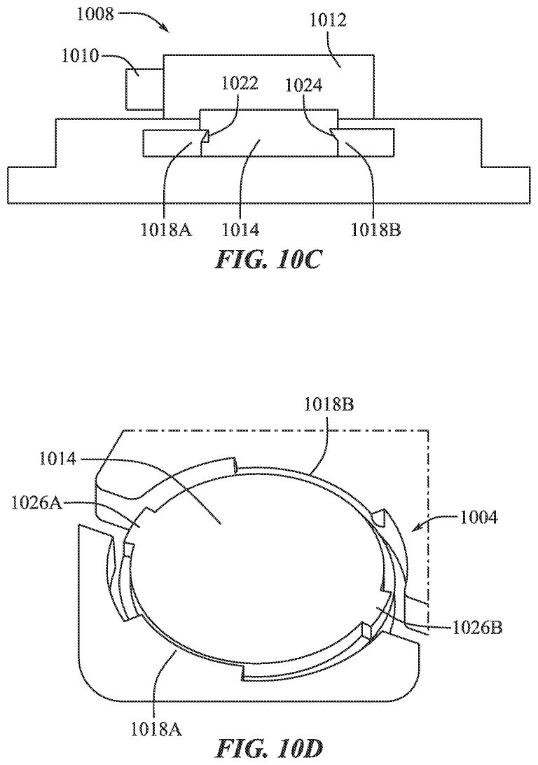

Any number or variety of components in any of the configurations described herein can be included in the electronic device. The components can include any combination of the features described herein and can be arranged in any of the various configurations described herein. The structure and arrangement of components of an electronic device having an enclosure and receptacle connector with structures described herein, and defining an internal volume, as well as the concepts regarding one or more detents, can apply not only to the specific examples discussed herein, but to any number of examples in any combination. Examples of one or more detents and other retaining mechanisms within the receptacle connector of an electronic device are described below, with reference to FIGS. 10A-10D.

FIGS. 10A and 10B show an electronic device 1000 including an enclosure 1002 and a receptacle connector 1004 disposed on the enclosure 1002. A cable assembly 1006, including a plug connector 1008 and a shielded cable 1010, can be operably coupled to the receptacle connector 1004. The plug connector 1008 can include a boot 1012 and a central protrusion 1014. The central protrusion 1014 can interlock within the receptacle connector 1004 to affix the plug connector 1008 to the electronic device 1000. For example, the central protrusion 1014 can form a channel 1016 (see FIG. 10C) which interlocks with one or more detents 1018A, 1018B disposed within the receptacle connector 1004. In some examples, the receptacle connector 1004 can form a cavity 1020 and the one or more detents 1018A, 1018B can be biased to at least partially extend within the cavity 1020. For example, the one or more detents 1018A, 1018B can be biased to engage the central protrusion 1014 while the central protrusion 1014 is disposed within the cavity 1020 yet slide or transition to permit insertion and extraction of the central protrusion 1014. Each of the one or more detents 1018A, 1018B can have a curved engagement surface which substantially conforms to a curved profile of the channel 1016 and or central protrusion 1014 (see FIG. 10B).

In some examples, a first portion 1022 of the channel 1016 can be defined by surfaces which are perpendicular to one another and therefore inhibit the first portion 1022 from being pulled out of contact with the detent 1018A. Conversely, a second portion 1024 of the channel 1016 can be defined by surfaces which are not perpendicular to one another and therefore enable the second portion 1024 to be pulled out of contact with the detent 1018B with relatively less force. In other words, the interface between the first portion 1022 of the channel 1016 and the detent 1018A can limit accidental or unwanted extraction of the plug connector 1008 from the receptacle connector 1004 (e.g., snagging the shielded cable 1010) by requiring a greater extraction force. Conversely, the sloped or slanted interface between the second portion 1024 of the channel 1016 and the detent 1018B can enable intentional extraction of the plug connector 1008 from the receptacle connector 1004 (e.g., prying or lifting the plug connector 1008).

FIG. 10D shows a bottom view of the central protrusion 1014 disposed within the receptacle connector 1004. In some examples, the central protrusion 1014 can form stops 1026A, 1026B which can prevent the plug connector 1008 from completely rotating within the receptacle connector 1004. For example, as the central protrusion 1014 is rotated, at least one of the stops 1026A, 1026B can rotate into contact with either the detent 1018A or the detent 1018B to prevent the central protrusion 1014 from undergoing a complete rotation within the receptacle connector 1004. For example, the stops 1026A, 1026B can prevent the central protrusion 1014 from rotating beyond 90 degrees of rotation.

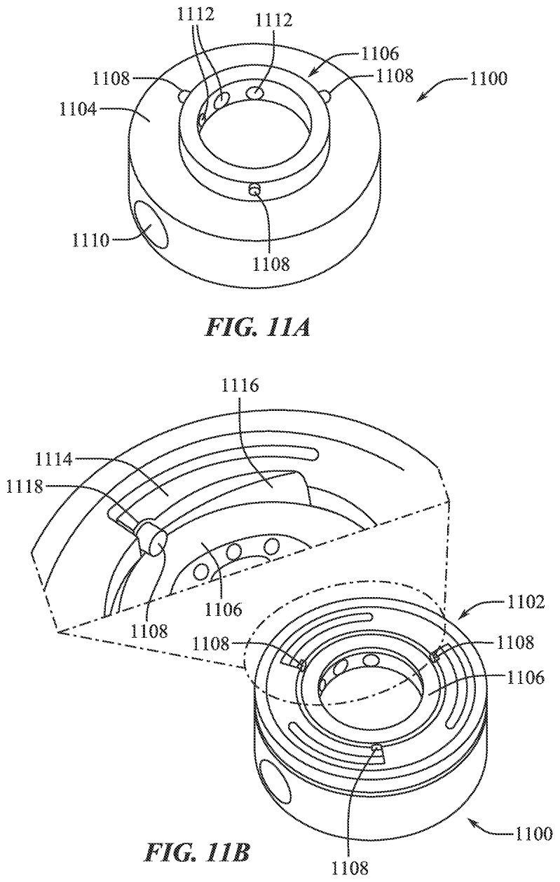

Any number or variety of components in any of the configurations described herein can be included in the electronic device. The components can include any combination of the features described herein and can be arranged in any of the various configurations described herein. The structure and arrangement of components of an electronic device having an enclosure and receptacle connector with structures described herein, and defining an internal volume, as well as the concepts regarding arms and plugs, can apply not only to the specific examples discussed herein, but to any number of examples in any combination. Examples of arms and other retaining mechanisms within the receptacle connector of an electronic device are described below, with reference to FIGS. 11A-11B.

FIG. 11A shows a plug connector 1100 for a cable assembly (not shown) which is configured to interlock with a receptacle connector 1102 (see FIG. 11B). The plug connector 1100 can include a boot 1104, a central protrusion 1106, and one or more pegs 1108 positioned radially about the central protrusion 1106. The boot 1104 can form an aperture 1110 enabling one or more shielded wires (not shown) to extend through the boot 1104 and electrical couple to one or more electrical contacts 1112 of the plug connector 1100.

FIG. 11B shows a bottom view of the central protrusion 1106 of the plug connector 1100 disposed within the receptacle connector 1102. The receptacle connector 1102 can form one or more arms 1114 configured to engage a respective peg 1108 to retain the central protrusion 1106 within the receptacle connector 1102. For example, when the central protrusion 1106 is inserted into the receptacle connector 1102, the peg 1108 can be placed within a track 1116 defined by the arm 1114 and the receptacle connector 1102. The central protrusion 1106 can thereafter be rotated to translate the peg 1108 along the track 1116 before reaching an ident or recess 1118 formed on the arm 1114 and at an end of the track 1116. The peg 1108 can be disposed within the recess 1118 to inhibit removal of the central protrusion 1106 from the receptacle connector 1102. In some examples, the arm 1114 can be biased to contact the peg 1108. For example, the arm 1114 can be coupled to the receptacle connector 1102 by a living hinge (i.e., the arm 1114 can be formed as part of the receptacle connector 1102 with a living hinge as shown in FIG. 11B).

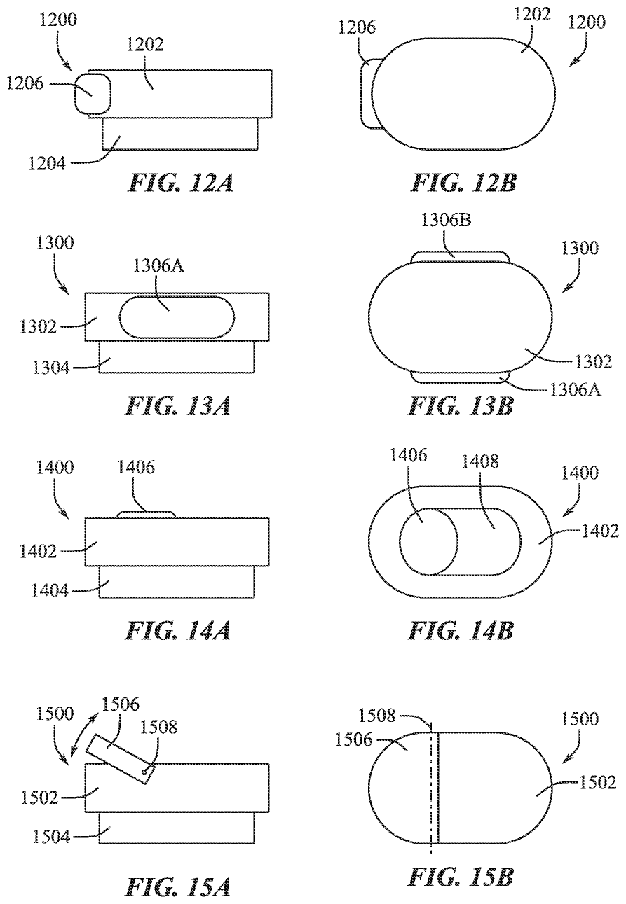

Any number or variety of components in any of the configurations described herein can be included in the electronic device. The components can include any combination of the features described herein and can be arranged in any of the various configurations described herein. The structure and arrangement of components of an electronic device having an enclosure and receptacle connector with structures described herein, and defining an internal volume, as well as the concepts regarding mechanisms for actuating the interlock between a plug connector and a receptacle connector, can apply not only to the specific examples discussed herein, but to any number of examples in any combination. Examples of a detent ring and other retaining mechanisms within the receptacle connector of an electronic device are described below, with reference to FIGS. 12A-15B.

FIGS. 12A and 12B show a plug connector 1200 including a boot 1202, a central protrusion 1204, and a button 1206. The boot 1202 can be substantially similar to, and can include some or all of, the features of the boots 114, 206, 406, 512, 612, 712, 812, 912, 1012, 1104. The central protrusion 1204 can be substantially similar to, and can include some or all of, the features of the central protrusions 116, 208, 408, 514, 914, 1014, 1106. The button 1206 can engage and/or disengage the plug connector 1200 to/from a receptacle connector (e.g., any of receptacle connectors 106, 300, 402, 504, 604, 704, 804, 904, 1004, 1102). For example, the button 1206 can be pressed toward the boot 1202 to engage or release the plug connector 1200 from the receptacle connector.

FIGS. 13A and 13B show a plug connector 1300 including a boot 1302, a central protrusion 1304, and a pair of buttons 1306A, 1306B. The boot 1302 can be substantially similar to, and can include some or all of, the features of the boots 114, 206, 406, 512, 612, 712, 812, 912, 1012, 1104. The central protrusion 1304 can be substantially similar to, and can include some or all of, the features of the central protrusions 116, 208, 408, 514, 914, 1014, 1106. The pair of buttons 1306A, 1306B can engage and/or disengage the plug connector 1300 to/from a receptacle connector (e.g., any of receptacle connectors 106, 300, 402, 504, 604, 704, 804, 904, 1004, 1102). For example, the pair of buttons 1306A, 1306B can be squeezed or depressed toward the boot 1302 to engage or release the plug connector 1300 from the receptacle connector.

FIGS. 14A and 14B show a plug connector 1400 including a boot 1402, a central protrusion 1404, and a slider 1406. The boot 1402 can be substantially similar to, and can include some or all of, the features of the boots 114, 206, 406, 512, 612, 712, 812, 912, 1012, 1104. The central protrusion 1404 can be substantially similar to, and can include some or all of, the features of the central protrusions 116, 208, 408, 514, 914, 1014, 1106. The slider 1406 can engage and/or disengage the plug connector 1400 to/from a receptacle connector (e.g., any of receptacle connectors 106, 300, 402, 504, 604, 704, 804, 904, 1004, 1102). For example, the slider 1406 can be transitioned within a slot 1408 formed on the boot 1402 to engage or release the plug connector 1400 from the receptacle connector.

FIGS. 15A and 15B show a plug connector 1500 including a boot 1502, a central protrusion 1504, and a latch 1506. The boot 1502 can be substantially similar to, and can include some or all of, the features of the boots 114, 206, 406, 512, 612, 712, 812, 912, 1012, 1104. The central protrusion 1504 can be substantially similar to, and can include some or all of, the features of the central protrusions 116, 208, 408, 514, 914, 1014, 1106.

The latch 1506 can engage and/or disengage the plug connector 1500 to/from a receptacle connector (e.g., any of receptacle connectors 106, 300, 402, 504, 604, 704, 804, 904, 1004, 1102). The latch 1506 can be coupled to the boot 1502 at a pivot axis 1508 and rotate about the pivot axis 1508. For example, a portion of the latch 1506 can be rotated toward the boot 1502 to engage the plug connector 1500 within the receptacle connector. Conversely, a portion of the latch 1506 can be lifted away from the boot 1502 to disengage the plug connector 1500 from the receptacle connector.

The disclosed systems and methods can, in some examples, incorporate personal information data. When used, personal information data should be gathered, stored, used, and transmitted pursuant to authorized and well established secure privacy policies and practices that are appropriate for the type of data collected, to implement and improve on the various embodiments described herein. The disclosed technology is not, however, rendered inoperable in the absence of such personal information data.

It will be understood that the details of the present systems and methods above can be combined in various combinations and with alternative components not specifically disclosed herein. The scope of the present systems and methods will be further understood by the following claims.

What is claimed is:

1. A receptacle connector of an electronic device, comprising:
a trim ring;
a base connected to the trim ring, the trim ring and the base defining a recess;
a detent disposed in the recess, the detent defining a channel configured to rotatably receive at least a portion of a corresponding plug connector;
an electrical contact disposed within the recess;
a raised portion disposed within the recess and extending from the base, the electrical contact coupled to the raised portion; and
a spring biasing the detent toward the raised portion.

2. The receptacle connector of claim 1, wherein the spring comprises one of a canted coil spring or a leaf spring.

3. The receptacle connector of claim 1, wherein:
the detent defines a first surface angled relative to a second surface; and
a flange of the plug connector extends into the channel and contacts the first surface.

4. The receptacle connector of claim 1, wherein:
the detent is configured to receive the portion of the plug connector when the receptacle connector is in a first orientation relative to the plug connector;
the detent is configured to inhibit extraction of the plug connector from the recess when the receptacle connector is in a second orientation relative to the plug connector; and
the receptacle connector is configured to permit rotation of the plug connector from the first orientation to the second orientation.

5. The receptacle connector of claim 4, wherein extracting the plug connector from the recess while the receptacle connector is in the first orientation requires less force than extracting the plug connector from the recess while the receptacle connector is in the second orientation.

6. The receptacle connector of claim 5, wherein the force required to extract the plug connector from the recess while the receptacle connector is in the second orientation is greater than 3 Nm.

7. The receptacle connector of claim 1, wherein:
the electrical contact comprises a first electrical contact; and
the receptacle connector further comprises a second electrical contact, the first electrical contact defining a first contact area that is different than a second contact area defined by the second electrical contact.

8. The receptacle connector of claim 1, wherein the detent comprises a first detent; and
the receptacle connector further comprising:
a second detent disposed in the recess;
a third detent disposed in the recess;
a first canted coil spring biasing the first detent toward the raised portion;
a second canted coil spring biasing the second detent toward the raised portion; and
a third canted coil spring biasing the third detent toward the raised portion.

9. The receptacle connector of claim 1, further comprising a seal disposed adjacent to the raised portion.

10. A plug connector, comprising:
a boot;
a central protrusion including an internal surface and an external surface, the internal surface defining a cavity;
a first metal flange having a first width extending from the external surface;
a second metal flange having a second width different than the first width extending from the external surface;
wherein the central protrusion is configured to be inserted into a corresponding receptacle connector when the central protrusion is in a first orientation; and
wherein the first and second metal flange are configured to prevent the central protrusion from being inserted into the corresponding receptacle connector when the central protrusion is in a second orientation.

11. The plug connector of claim 10, further comprising an electrical contact disposed adjacent to the internal surface and extending into the cavity.

12. The plug connector of claim 11, wherein the electrical contact comprises one of a plurality of electrical contacts disposed about the internal surface and extending into the cavity.

13. The plug connector of claim 10, wherein the external surface of the central protrusion is substantially parallel to the internal surface of the central protrusion.

14. The plug connector of claim 10, wherein the central protrusion has a circular cross-sectional profile.

15. The plug connector of claim 10, further comprising a magnet disposed within the boot.

16. The plug connector of claim 10, further comprising a seal disposed on the first metal flange and the second metal flange.

17. The plug connector of claim 10, further comprising:
a third metal flange extending from the external surface;
wherein the first metal flange, the second metal flange, and the third metal flange are offset.

18. A cable assembly, comprising:
a cable;
a plug connector electrically coupled to the cable, the plug connector comprising:
a boot;
a central protrusion at least partially disposed within the boot, the central protrusion forming an internal surface and an external surface, the internal surface defining a cavity having a circular cross-sectional profile;
electrical contacts disposed radially about the internal surface and extending into the cavity; and
flanges radially disposed about the external surface and extending laterally from the external surface.

19. The cable assembly of claim 18, wherein the flanges include a first flange, a second flange, and a third flange, the first flange having a first width, the second flange having a second width, the third flange having a third width different from the first width and the second width.

20. The cable assembly of claim 18, wherein the cable is electrically coupled to a power source.

21. A head-mounted display, comprising:
a display portion;
an electrical power source;
a support coupled to the display portion, the support comprising:
an enclosure; and
a receptacle connector at least partially disposed within the enclosure; and
a cable assembly electrically coupling the electrical power source and the support.

22. The head-mounted display of claim 21, wherein the support comprises a band configured to at least partially wrap around a head, the band coupled to the display portion at a first location and at a second location.

23. The head-mounted display of claim 21, wherein:
the support comprises a first support; and
the head-mounted display further comprises a second support coupled to the display portion.

24. The head-mounted display of claim 21, wherein the display portion comprises a light-emitting diode (LED) display, an organic light-emitting diode (OLED) display, a liquid-crystal display (LCD) display, or a micro-LED display.

25. The head-mounted display of claim 21, further comprising a printed circuit board disposed within a cavity defined by the enclosure, wherein the receptacle connector is electrically coupled to the printed circuit board.

26. The head-mounted display of claim 25, wherein the support is electrically coupled to the display portion.

27. The head-mounted display of claim 21, wherein the receptacle connector comprises:
a trim ring;
a base disposed within the enclosure and connected to the trim ring, the trim ring and the base defining a recess;
a detent disposed in the recess, the detent defining a channel configured to receive at least a portion of a corresponding plug connector; and
an electrical contact disposed within the recess.

28. A support for a head-mounted display, comprising:
an enclosure configured to be coupled to a display portion of the head-mounted display;
an electrically conductive wire disposed within the enclosure;
a receptacle connector disposed on a distal end of the enclosure and electrically connected to the electrically conductive wire, the electrically conductive wire configured to at least partially define an electrical path between the receptacle connector and the display portion; and
a display portion connector disposed on a proximal end of the enclosure and electrically connected to the electrically conductive wire.

29. The support of claim 28, wherein:
the display portion connector at the proximal end comprises a plurality of contacts; and
the receptacle connector disposed at the distal end comprises:
a trim ring;
a base connected to the trim ring, the trim ring and the base defining a recess; and
a detent disposed in the recess, the detent defining a channel configured to rotatably receive at least a portion of a corresponding plug connector.

30. The support of claim 29, wherein the enclosure is configured to be electrically coupled to the display portion at the proximal end.

31. The support of claim 29, wherein the receptacle connector further comprises a canted coil spring biasing the detent.

32. The support of claim 28, further comprising a printed circuit board connected to the electrically conductive wire.

33. A support for a head-mounted display, comprising:
an enclosure defining a proximal end and a distal end; and
a receptacle connector disposed at least partially within the enclosure between the proximal end and the distal end, the receptacle connector configured to rotatably receive a corresponding plug connector;
the receptacle connector comprising:
a trim ring;
a base connected to the trim ring, the trim ring and the base defining a recess; and
a biased detent disposed in the recess, the biased detent defining a channel configured to rotatably receive at least a portion of the corresponding plug connector.

34. The support of claim 33, wherein:
the receptacle connector is configured to enable rotation of the plug connector relative to the receptacle connector in a first direction; and
the receptacle connector is configured to substantially inhibit rotation of the plug connector relative to the receptacle connector in a second direction.

35. The support of claim 34, wherein:
the receptacle connector is configured to enable the rotation of the plug connector relative to the receptacle connector in the first direction more than about 15 degrees; and
the receptacle connector is configured to enable the rotation of the plug connector relative to the receptacle connector in the second direction less than about 15 degrees.

36. The support of claim 33, wherein the receptacle connector further comprises:
a raised portion disposed within the recess and extending from the base; and
a spring or a foam forcing the biased detent toward the raised portion.

37. The support of claim 33, wherein:
the biased detent is configured to receive the portion of the plug connector when the receptacle connector is in a first orientation relative to the plug connector; and
the biased detent is configured to inhibit extraction of the plug connector from the recess when the receptacle connector is in a second orientation relative to the plug connector.

38. The support of claim 33, wherein the receptacle connector is disposed at least partially within the enclosure closer to the proximal end than the distal end.

39. The support of claim 33, wherein the receptacle connector is disposed at least partially within the enclosure closer to the distal end than the proximal end.

40. The support of claim 33, further comprising a band portion coupled to the support, the band portion configured to at least partially encircle a head.
